(19) United States
(12) Patent Application Publication
(10) Pub. No.: US 2019/0003851 A1
(43) Pub. Date: Jan. 3, 2019

(54) DISPLAY DEVICE

(71) Applicant: MITSUBISHI ELECTRIC CORPORATION, Tokyo (JP)

(72) Inventors: Kotoyu ISHIKAWA, Tokyo (JP); Makoto OTSURU, Tokyo (JP); Satoshi SAKURAI, Tokyo (JP)

(73) Assignee: MITSUBISHI ELECTRIC CORPORATION, Tokyo (JP)

(21) Appl. No.: 16/064,954

(22) PCT Filed: Mar. 18, 2016
(86) PCT No.: PCT/JP2016/058701

§ 371 Date: Jun. 21, 2018

(51) Int. Cl. G01C 21/36; G09G 5/377

(52) U.S. Cl. CPC G01C 21/3676; G09G 5/377; G09G 5/38; G09G 2340/0492; G09G 2354/00; G01C 21/367

(57) ABSTRACT

A display device includes: a first generator to generate first display information for displaying, in a first area, a first map and a first route including a first position in the first area; a second generator to calculate an intersection of an entire route with a boundary of the first area, calculate a tangential area in which a second route connecting a second position and the intersection is inscribed, determine a scale at which the tangential area is included within a second area when the first route and the second route are displayed in such a manner as to be connected to each other at the intersection, and generate second display information for displaying, in the second area, a second map with the scale and the second route; and a controller to control displaying the first display information and the second display information in a combined manner on a display.

### TECHNICAL FIELD

The present invention relates to a display device that displays a route on a map.

### BACKGROUND ART

A display device that displays a route on a map is provided in, for example, a car navigation system installed in a vehicle.

In a car navigation system, for example, it is assumed that the driver sets a route and travels on roads in accordance with the route set on a map displayed on a display of the car navigation system. In the displayed map, to allow roads on the map to be easily associated with roads in the real world, it is required to display, in detail, the angle or shape of the road on which the driver is running or a road connecting to the road on which the driver is running, and the positional relationship with a roadside shop, such as whether the roadside shop appears on the left or right side in running, or how far it is to the shop. For this purpose, it is desirable that the periphery of the own vehicle be displayed using a large-scale map (referred to below as a “detailed map”) with a scale of, for example, 1/10, 1/20, or the like.

On the other hand, to obtain an overview of the position of the own vehicle and the entire route about to be traveled, the driver desires to know the positional relationships between the road on which the driver is traveling and landmarks, such as major roads such as national roads or prefectural roads, large department stores, rivers, mountains, major cities, or destinations. For this purpose, it is desirable to display a small-scale map (referred to below as a “wide-area map”) with a scale of, for example, 1/10000, 1/100000, or the like such that the entire route is included within the screen.

Conventionally, to simultaneously achieve the above requirements, maps with different scales are simultaneously displayed. For example, a technique is disclosed that divides a screen into two left and right areas, and displays a detailed map on the right side and a wide-area map on the left side. However, the conventional technique has a problem in that it is difficult to intuitively perceive which area of the wide-area map corresponds to the area of the displayed detailed map. Also, it has another problem in that discomfort is caused by display of an own vehicle mark indicating the position of the own vehicle on both the detailed map and wide-area map.

To remedy this, a conventional display device (see, for example, Patent Literature 1) shifts the position of an area including a destination displayed on a wide-area map in such a manner as to draw the area toward the center of a screen, and displays, on a display, the wide-area map, a detailed map, and a map between the area including the destination and an area including the position of an own vehicle displayed on the detailed map while varying the scale of the map continuously or in a stepwise manner, in order to simultaneously display, on the same screen, the area including the destination and the area including the position of the own vehicle. By operating as above, when a detailed map is displayed, and a destination or an area including the destination is outside a frame of a screen of a display portion, the conventional technique of Patent Literature 1 can simultaneously display the two points (the position of the own vehicle and the destination) on the same screen, and display the maps in such a manner that the positional relationship between the position of the own vehicle and the destination can be known, without displaying multiple marks of the position of the own vehicle.

Another conventional display device (see, for example, Patent Literature 2) simultaneously displays a detailed map area including the position of an own vehicle and a wide-area map area including the periphery of the detailed map area and having a scale different from that of the detailed map, provides a correction area between the detailed map area and the wide-area map area, and displays, in the correction area, a virtual road connecting two road sections of the same road that exist in the detailed map and wide-area map. By operating as above, the conventional technique of Patent Literature 2 can simultaneously display, on the same screen, the detailed map and wide-area map that have different scales without displaying multiple marks of the position of the own vehicle, and further can smoothly connect the two maps having different scales.

### CITATION LIST

### Patent Literature

Patent Literature 1: Japanese Patent Application Publication No. 2011-227434

Patent Literature 2: Japanese Patent Application Publication No. 2000-193468

### SUMMARY OF INVENTION

### Technical Problem

However, in the conventional technique of Patent Literature 1, since the map is deformed so that the two points are included within the single screen, part of the route may be excluded from the screen depending on the shape of the route while the position of the own vehicle and the destination exist in the screen.

Also, in the conventional technique of Patent Literature 2, since it is configured to connect two road sections of the same road that exist in the detailed map and wide-area map, there is a problem in that, when a road included in the route is, for example, very narrow, and thus is displayed on only either the detailed map or the wide-area map, or displayed on neither of them, the route line is discontinuous in the correction area. There is also another problem in that, depending on the scale of the wide-area map, part of the route may be excluded from the screen.

That is, the above conventional display device has a problem in that, when the maps with the different scales are simultaneously displayed on the same screen, the route is not necessarily entirely displayed, and in some cases, the entire route cannot be seen at a glance.

The present invention has been made to solve the problems as described above, and is intended to provide a display device that displays an entire route within a single screen in a continuous manner when simultaneously displaying, on the same screen, maps with different scales.

### Solution to Problem

A display device according to the present invention includes: a first display information generator to generate first display information that is information for displaying, in a first area, a first map and a first route including a first position in the first area; a second display information generator to calculate an intersection of an entire route with a boundary of the first area, calculate a tangential area in which a second route connecting a second position and the intersection is inscribed, determine a scale at which the tangential area is included within a second area including the second route when the first route and the second route are displayed in such a manner as to be connected to each other at the intersection, and generate second display information that is information for displaying, in the second area, a second map with the scale and the second route; and a display controller to control displaying the first display information and the second display information in a combined manner on a display.

Another display device according to the present invention includes: a first display information generator to generate first display information that is information for displaying, in a first area, a first position in the first area, a first route including the first position in the first area, and a first map; a second display information generator to generate second display information that is information for displaying, in a second area, a second position in the second area, an entire second route including the second position in the second area, and a second map; a third display information generator to calculate a first intersection of an entire route with a boundary of the first area, calculate a second intersection of the entire route with a boundary of the second area, and generate third display information that is information for displaying, in a third area that is a remaining area obtained by subtracting the first area and the second area from an entire area, a route connecting the first intersection and the second intersection; and a display controller to control displaying the first display information, the second display information, and the third display information in a combined manner on a display.

### Advantageous Effects of Invention

A display device according to the present invention can display an entire route within a single screen in a continuous manner when simultaneously displaying, on the same screen, maps with different scales. Thus, even when maps with different scales are simultaneously displayed on the same screen, an entire route can be seen at a glance.

### BRIEF DESCRIPTION OF DRAWINGS

FIG. 1 is a diagram illustrating a configuration of a car navigation system including a display device according to a first embodiment.

FIG. 2 is a diagram illustrating a hardware configuration of the car navigation system including the display device according to the first embodiment.

FIG. 3 is a diagram illustrating, in detail, a configuration of a setting processor according to the first embodiment.

FIG. 4 is a diagram illustrating, in detail, a configuration of a detailed map generator according to the first embodiment.

FIG. 5 is a diagram illustrating, in detail, a configuration of a wide-area map generator according to the first embodiment.

FIG. 6 is a diagram illustrating, in detail, a configuration of a wide-area adjuster according to the first embodiment.

FIG. 7 is an example of display by a display according to the first embodiment.

FIG. 8 is a conceptual diagram for explaining a tangential area of the first embodiment.

FIG. 9 is a flowchart illustrating the flow of the operation of the display device according to the first embodiment.

FIG. 10 is a flowchart illustrating the flow of the operation of the setting processor of the first embodiment.

FIG. 11 is a flowchart illustrating the flow of the operation of the detailed map generator of the first embodiment.

FIG. 12 is a flowchart illustrating the flow of the operation of the wide-area map generator of the first embodiment.

FIG. 13 is a diagram illustrating a configuration of a car navigation system including a display device according to a second embodiment.

FIG. 14 is a diagram illustrating, in detail, a configuration of a wide-area map generator according to the second embodiment.

FIG. 15 is a diagram illustrating, in detail, a configuration of an intermediate map generator according to the second embodiment.

FIG. 16 is an example of display by a display according to the second embodiment.

FIG. 17 is a flowchart illustrating the flow of the operation of the display device according to the second embodiment.

FIG. 18 is a flowchart illustrating the flow of the operation of the wide-area map generator of the second embodiment.

FIG. 19 is a flowchart illustrating the flow of the operation of the intermediate map generator of the second embodiment.

FIG. 20 is a diagram illustrating a configuration of a car navigation system including a display device according to a third embodiment.

FIG. 21 is a diagram illustrating, in detail, a configuration of a detailed map generator according to the third embodiment.

FIG. 22 is a diagram illustrating, in detail, a configuration of a wide-area map generator according to the third embodiment.

FIG. 23 is an example of display by a display according to the third embodiment.

FIG. 24 is a flowchart illustrating the flow of the operation of the display device of the third embodiment.

FIG. 25 is a flowchart illustrating the flow of the operation of the detailed map generator of the third embodiment.

FIG. 26 is a flowchart illustrating the flow of the operation of the wide-area map generator of the third embodiment.

### DESCRIPTION OF EMBODIMENTS

Examples in which a display device according to the present invention is applied to a car navigation system will be described below with reference to the drawings.

### First Embodiment

A car navigation system to which a display device of the present invention is applied is installed, for example, at a location where the car navigation system is easy to see for a driver, in or on a dashboard of a vehicle. The car navigation system performs route search, route guidance, and display of a route and a map on the basis of acquisition of the position of the own vehicle or input of a destination by a user. In addition, the car navigation system includes a display device of the present invention, thereby displaying an entire route on a display.

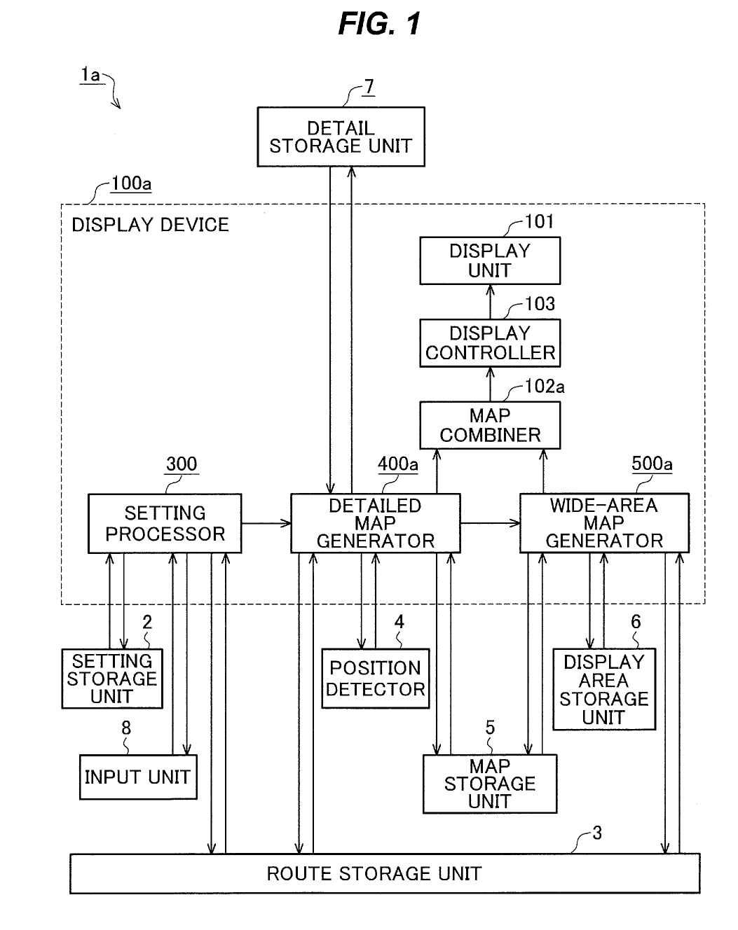

FIG. 1 is a diagram illustrating a configuration of a car navigation system 1a including a display device 100a according to a first embodiment of the present invention.

The car navigation system 1a includes a setting storage unit 2 that stores settings for display, a route storage unit 3 that stores a set route, a position detector 4 that detects the position of the own vehicle, a map storage unit 5 that stores maps, a display area storage unit 6 that stores a display area of the display, a detail storage unit 7 that stores settings for display of a detailed map, an input unit 8 that receives input from a user, and the display device 100a. These components make it possible to display an entire route within a single screen in a continuous manner when maps with different scales are simultaneously displayed on the same screen. Here, the detailed map is a map with a large scale, such as 1/10 or 1/20. Specifically, for example, the detailed map is a map in which a predetermined distance of 20 pixels on the screen of a display unit 101 is defined as 10 m. The scale of the detailed map is not limited to 1/10, and may be ⅕, 1/30, 1/100, or the like. The detailed map is not limited to a map in which a predetermined distance of 20 pixels on the screen of the display unit 101 is defined as 10 m, and may be a map in which a predetermined distance of 20 pixels on the screen of the display unit 101 is defined as 20 m, 50 m, or other distances, or a map in which a predetermined distance of 10, 50, 100, or other numbers of pixels on the screen of the display unit 101 is defined as 10 m. The detailed map is an example of a first map.

The input unit 8 is an interface through which the user inputs the orientation of a displayed map. For example, when the user wants to situate the south side of the map at the upper side of the display, the user makes such a setting. A heading-up orientation or other orientations may be set.

The input unit 8 also allows the user to input the number of maps simultaneously displayed on the display unit 101. In the first embodiment, when there is no input, the number of maps displayed by default is 1. The first embodiment describes a case where the user has input 2 as the number of displayed maps. Hereinafter, of the displayed maps, the map with a larger scale will be referred to as the detailed map, and the map with a smaller scale will be referred to as the wide-area map. Here, the wide-area map is a map with a small scale, such as 1/10000 or 1/100000. Specifically, for example, the wide-area map is a map in which a predetermined distance of 20 pixels on the screen of the display unit 101 is defined as 1 km. The scale of the wide-area map is not limited to 1/10000, and may be 1/20000, 1/100000, 1/1000000, or the like. The wide-area map is not limited to a map in which a predetermined distance of 20 pixels on the screen of the display unit 101 is defined as 1 km, and may be a map in which a predetermined distance of 20 pixels on the screen of the display unit 101 is defined as 2 km, 5 km, 10 km, or other distances, or a map in which a predetermined distance of 10, 50, 100, or other numbers of pixels on the screen of the display unit 101 is defined as 1 km.

The setting storage unit 2 stores the settings for display, and stores the orientation of the map displayed when the user has not set the orientation of the displayed map through the input unit 8. For example, it stores the settings such that the orientation of the map displayed when the user has not set the orientation of the displayed map through the input unit 8 is a heading-up orientation. It may store other orientations, such as a north-up or southwest-up orientation, other than the heading-up orientation.

It is also possible that the input unit 8 is not provided, and only the setting storage unit 2 is provided. In this case, the orientation of the displayed map is fixed to the orientation previously stored in the setting storage unit 2.

The route storage unit 3 stores a route set by the user. The route set by the user is an example of an entire route.

The position detector 4 detects the position of the own vehicle. The position of the own vehicle is, for example, coordinate information on a map. The position of the own vehicle is an example of a first position.

The map storage unit 5 stores multiple maps with different scales. Each of the maps with the scales is provided with information on the background, including mountains, rivers, towns, or the like, information on roads, and information on trademarks or the like. The information on the background, information on roads, and information on trademarks or the like are information on colors, shapes, positions, or the like for display on the display, and information on the names, types, opening and closing times, or the like of shops regarding the trademarks.

The display area storage unit 6 stores the displayable area of the display. For example, it stores pixel data.

The detail storage unit 7 stores settings for displaying the detailed map. The detail will be described later.

The display device 100a simultaneously displays maps with different scales on the same screen and displays an entire route within the single screen in a continuous manner. The display device 100a includes the display unit 101 that performs display, a setting processor 300 that performs setting for display of the maps, a detailed map generator 400a that generates the detailed map, a wide-area map generator 500a that generates the wide-area map, a map combiner 102a that combines the generated detailed map and wide-area map, and a display controller 103 that performs control for causing the display unit 101 to display the combined map. The setting processor 300, detailed map generator 400a, and wide-area map generator 500a will be described in detail later.

The display unit 101 performs display under the control of the display controller 103. For example, it performs display in accordance with signals sent from the display controller 103.

The map combiner 102a combines the detailed map generated by the detailed map generator 400a and the wide-area map generated by the wide-area map generator 500a. For example, each of the detailed map and wide-area map is associated with where and how widely the map is displayed on the display, and the detailed map and wide-area map are combined according to them.

The display controller 103 determines a coordinate transformation matrix for the combined map, converts it into a signal that can be transmitted to the display unit 101 and read by the display unit 101, and sends the signal to the display unit 101. For example, the display controller 103 determines a coordinate transformation matrix from a latitude and longitude coordinate system of the combined map, converts it into pixel data, converts it into a signal that can be transmitted to the display unit 101 and read by the display unit 101, and sends the signal to the display unit 101. The display controller 103 performs control for causing the display unit 101 to display the map combined by the map combiner 102a.

It has been described that the display controller 103 determines a coordinate transformation matrix for the combined map, converts it into a signal that can be transmitted to the display unit 101 and read by the display unit 101, and sends the signal to the display unit 101. However, determining a coordinate transformation matrix for the combined map and converting it into a signal that can be transmitted to the display unit 101 and read by the display unit 101 may be performed by each of the detailed map generator 400a and wide-area map generator 500a, or may be performed by the map combiner 102a or the like.

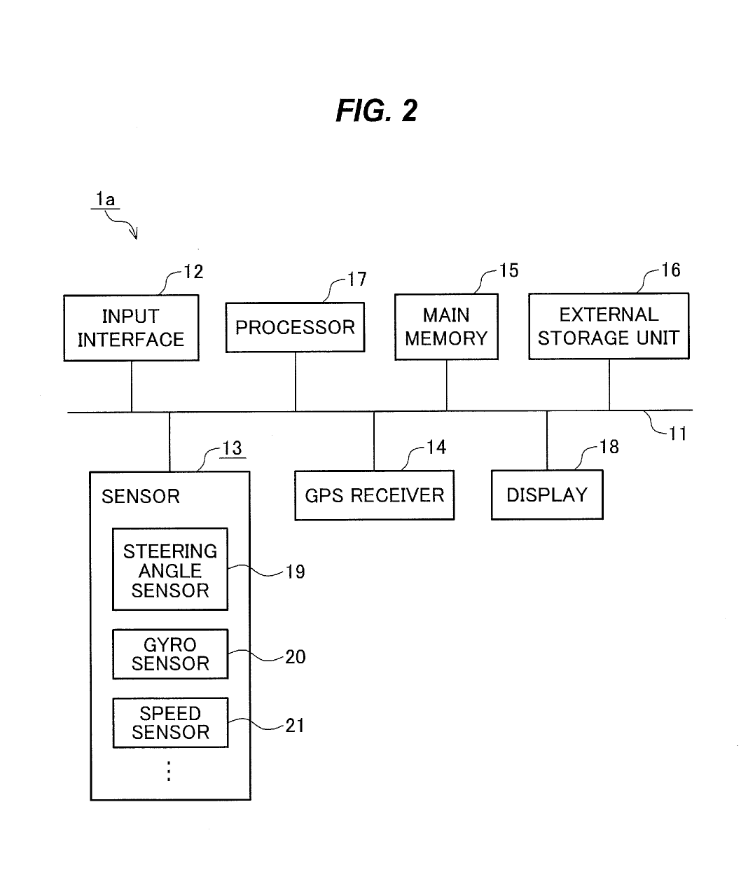

FIG. 2 is a diagram illustrating a hardware configuration of the car navigation system 1a including the display device 100a according to the first embodiment of the present invention. The configuration of the car navigation system 1a including the display device 100a according to the first embodiment of the present invention will be described with reference to FIG. 2.

In the first embodiment, the car navigation system 1a including the display device 100a is a computer. The car navigation system 1a includes hardware components: a bus 11 that is a signal path, an input interface 12 that is a device for input by the user, a sensor 13 that detects the position of the own vehicle, a GPS receiver 14 that receives GPS data, a main memory 15 that is a work area, an external storage device 16 that stores programs, maps, or the like, a processor 17 that reads and executes the programs of the external storage device 16 that have been loaded into the main memory 15, and a display 18 that displays results from the respective devices. The display device 100a is implemented by part of the processor 17 and the display 18.

The bus 11 is a signal path that electrically connects between the devices and through which information is exchanged.

The input interface 12 is a device through which the user inputs operation of the car navigation system 1a and inputs information on a starting point, a destination, a transit point (or via point), or the like in route setting. The input unit 8 is implemented by the input interface 12. The input interface 12 is operation buttons, a touch panel, a mouse, a keyboard, or other devices.

The sensor 13 includes a steering angle sensor 19 that detects the steering angle of the own vehicle, a gyro sensor 20 that detects the angular velocity, a speed sensor 21 that detects the speed, or the like, and detects information on the vehicle state. The sensor 13 can also calculate the position of the own vehicle from the detected information on the vehicle state. In this embodiment, the steering angle sensor 19, gyro sensor 20, and speed sensor 21 are provided, but the sensor is not limited to this, and the number of sensors may be one or plural. The position detector 4 is implemented by the sensor 13.

The GPS receiver 14 functions as a receiver that receives GPS data. The GPS receiver 14 is, for example, a communication chip or a network interface card (NIC). The position detector 4 is implemented by the GPS receiver 14.

Although it has been described that the position detector 4 is implemented by the sensor 13 and GPS receiver 14, both or either of them may be used.

The main memory 15 functions as a work area into which programs stored in the external storage device 16 are loaded. The main memory 15 is, for example, a random access memory (RAM).

The external storage device 16 stores information, such as map information for each scale and road information for each road section that is composed of a sequence of points having coordinates, and programs for implementing functions, such as a program for generating a map and a program for generating a route. The external storage device 16 is, for example, a read only memory (ROM), a flash memory, or a hard disk drive (HDD). The external storage device 16 also stores an operating system (OS). The setting storage unit 2, route storage unit 3, map storage unit 5, display area storage unit 6, and detail storage unit 7 are implemented by the external storage device 16.

In the above description, the setting storage unit 2, route storage unit 3, map storage unit 5, display area storage unit 6, and detail storage unit 7 are implemented by the external storage device 16, but they may be implemented by the main memory 15 or processor 17.

The processor 17 is connected to the other devices through the bus 11 and controls the other devices. The processor 17 reads and executes programs of the external storage device 16 that have been loaded into the main memory 15. At least part of the OS stored in the external storage device 16 is loaded into the main memory 15, and the processor 17 executes the programs while executing the OS. The processor 17 is an integrated circuit (IC) that performs processing. The processor 17 is, for example, a central processing unit (CPU). In this embodiment, the number of processors 17 is one, but may be plural. The multiple processors 17 may execute the programs in cooperation. The processor 17 reads and executes the programs of the external storage device 16 that have been loaded into the main memory 15, thereby implementing the setting processor 300, detailed map generator 400a, wide-area map generator 500a, map combiner 102a, and display controller 103.

The display 18 displays results from the respective devices. The display 18 is, for example, a liquid crystal display (LCD). The display unit 101 is implemented by the display 18. In the above description, the display unit 101 is an LCD, but it may be an organic electroluminescence (EL) display. Also, in the above description, the display unit 101 is a display, but it may be anything, such as a projector or a touch panel, that performs display.

Information, data, signal values, variable values, or the like indicating results from the respective devices are stored in the main memory 15, the external storage device 16, or a register or cache memory in the processor 17.

The programs may be stored in a portable recording medium, such as a magnetic disc, a flexible disc, an optical disc, a compact disc, or a digital versatile disc (DVD).

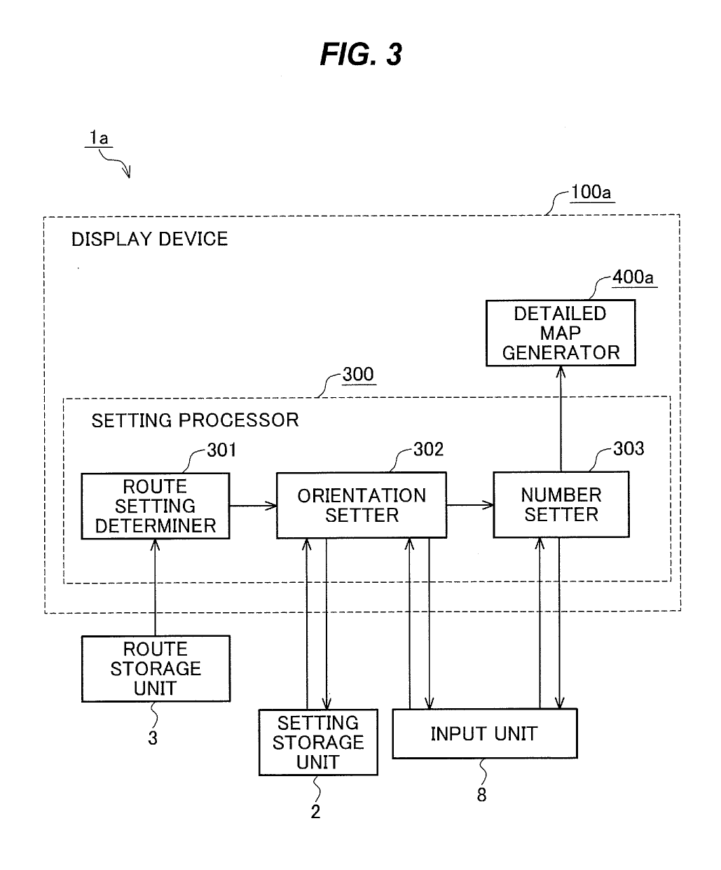

FIG. 3 is a diagram illustrating, in detail, a configuration of the setting processor 300 according to the first embodiment of the present invention. The setting processor 300 will be described with reference to FIG. 3.

The setting processor 300 includes a route setting determiner 301 that determines whether a route has been set, an orientation setter 302 that sets the orientation of the displayed map, and a number setter 303 that sets the number of displayed maps.

The route setting determiner 301 determines whether the user has set a route, and determines whether to continue a display process according to the present invention.

When the route setting determiner 301 determines that the display process according to the present invention is to be continued, the orientation setter 302 sets the orientation of the displayed map. For example, when the user has input, into the input unit 8, the orientation of the displayed map, the input orientation is set as the orientation of the displayed map. When the user has not input, into the input unit 8, the orientation of the displayed map, the orientation stored in the setting storage unit 2 is set as the orientation of the displayed map.

It is also possible that the input unit 8 is not provided and only the setting storage unit 2 is provided. In this case, the orientation stored in the setting storage unit 2 is originally set as the orientation of the displayed map.

The number setter 303 sets a number input by the user into the input unit 8 as the number of maps simultaneously displayed on the display unit 101. In the first embodiment, when there is no input, the number of maps displayed by default is 1. The first embodiment describes a case where the user has input 2 as the number of displayed maps. It is also possible that the input unit 8 and number setter 303 are not provided and two maps are automatically displayed such that the position of the own vehicle and the destination are displayed on the same screen. The destination is an example of a second position.

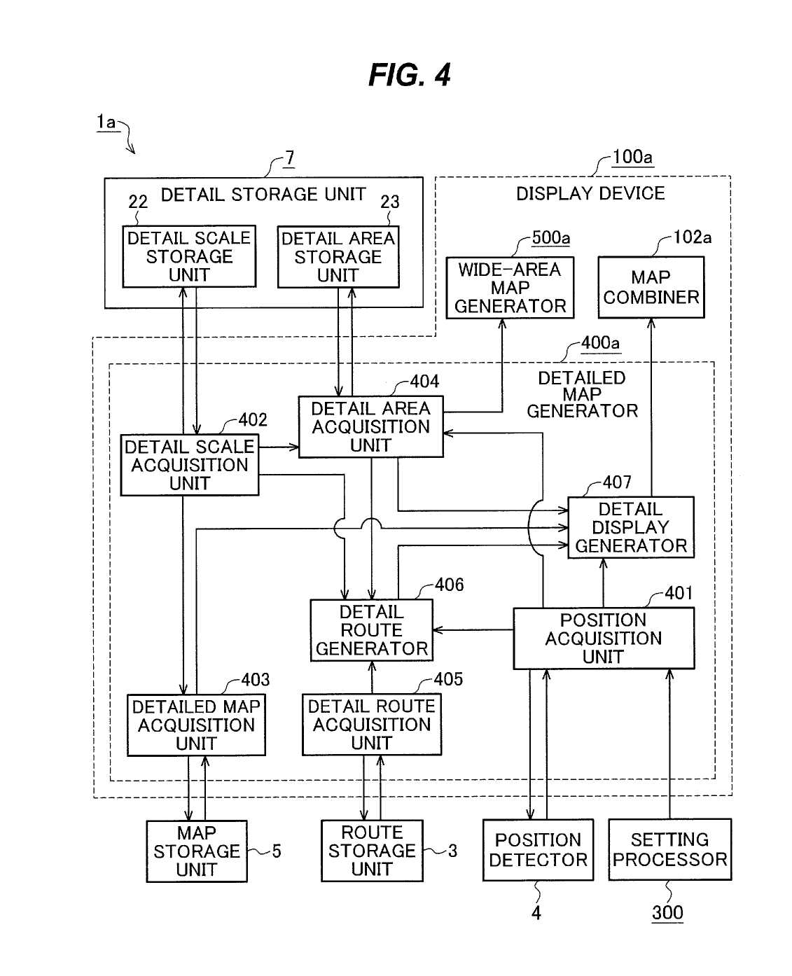

FIG. 4 is a diagram illustrating, in detail, a configuration of the detailed map generator 400a according to the first embodiment of the present invention. The detail storage unit 7 and detailed map generator 400a will be described with reference to FIG. 4.

The detail storage unit 7 includes a detail scale storage unit 22 that stores the value of the scale of the detailed map, and a detail area storage unit 23 that stores the area in which the detailed map is displayed on the display. The detailed map generator 400a includes a position acquisition unit 401 that acquires the position of the own vehicle and the orientation of the displayed map, a detail scale acquisition unit 402 that acquires the value of the scale of the detailed map, a detailed map acquisition unit 403 that acquires a map used for generating the detailed map, a detail area acquisition unit 404 that acquires the area in which the detailed map is displayed on the display, a detail route acquisition unit 405 that acquires a route set by the user, a detail route generator 406 that generates a route displayed on the detailed map, and a detail display generator 407 that generates display information that is information for displaying the detailed map. The display information that is information for displaying the detailed map is an example of first display information, and the detail display generator 407 is an example of a first display information generator.

The detail scale storage unit 22 stores the value of the scale of the detailed map. In the first embodiment, the scale of the detailed map is a stored fixed value, but it may be a value input by the user or a calculated value.

The detail area storage unit 23 stores the area in which the detailed map is displayed on the display. In the first embodiment, the area in which the detailed map is displayed on the display is a stored fixed value, but it may be a value input by the user, a calculated value, or the like. The area in which the detailed map is displayed on the display is an example of a first area.

The position acquisition unit 401 acquires the position of the own vehicle from the position detector 4, and the orientation of the displayed map set by the setting processor 300 from the setting processor 300.

The detail scale acquisition unit 402 acquires the value of the scale of the detailed map from the detail scale storage unit 22.

The detailed map acquisition unit 403 acquires, from the map storage unit 5, a map with a scale equal to the value of the scale of the detailed map sent by the detail scale acquisition unit 402.

The detail area acquisition unit 404 acquires, from the detail area storage unit 23, the area in which the detailed map is displayed on the display. The detail area acquisition unit 404 also acquires the orientation of the displayed map from the position acquisition unit 401 and the value of the scale of the detailed map from the detail scale acquisition unit 402, and associates them with the area in which the detailed map is displayed on the display.

The detail route acquisition unit 405 acquires the route set by the user.

The detail route generator 406 generates the route displayed on the detailed map. The detail route generator 406 generates display information that is information on the route set by the user within the display range of the detailed map, from the position of the own vehicle, the orientation of the displayed map, the value of the scale of the detailed map, the area in which the detailed map is displayed on the display, and the route set by the user. The route displayed on the detailed map is an example of a first route.

The detail display generator 407 generates display information that is information for displaying the detailed map. The detail display generator 407 acquires the position of the own vehicle, the orientation of the displayed map, the map with the scale equal to the value of the scale of the detailed map, the area in which the detailed map is displayed on the display, and the display information that is information on the route displayed on the detailed map, and generates the display information that is information for displaying the detailed map. In the generated display information, the route and the position of the own vehicle are superimposed on the detailed map, which is provided with information on the background, including mountains, rivers, towns, or the like, information on roads, and information on trademarks or the like.

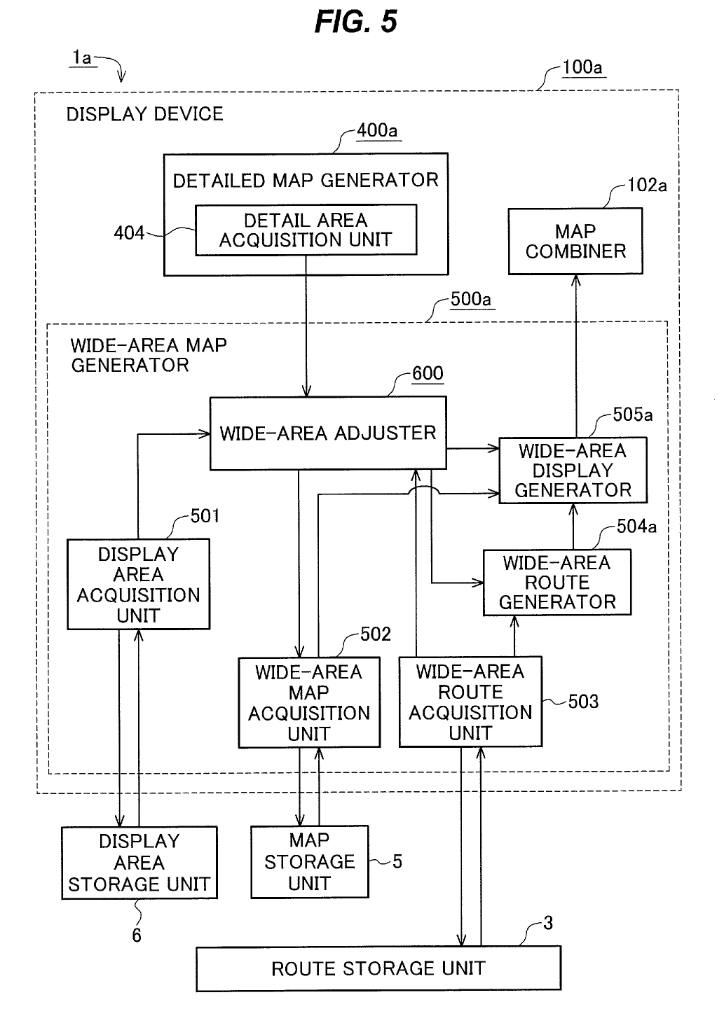

FIG. 5 is a diagram illustrating, in detail, a configuration of the wide-area map generator 500a according to the first embodiment of the present invention. The wide-area map generator 500a will be described in detail with reference to FIG. 5.

The wide-area map generator 500a includes a wide-area adjuster 600 that calculates the scale of the wide-area map, an intersection of the route with a boundary between the detailed map and the wide-area map, and the area in which the wide-area map is displayed on the display, a display area acquisition unit 501 that acquires the displayable area of the display, a wide-area map acquisition unit 502 that acquires a map used for generating the wide-area map, a wide-area route acquisition unit 503 that acquires the route set by the user, a wide-area route generator 504a that generates a route displayed on the wide-area map, and a wide-area display generator 505a that generates display information that is information for displaying the wide-area map.

When the maps with the different scales are simultaneously displayed on the same screen, the wide-area adjuster 600 calculates the scale of the wide-area map so that the entire route can be displayed on the single screen in a continuous manner. The wide-area adjuster 600 also calculates an intersection of the route with the boundary between the detailed map and the wide-area map. The wide-area adjuster 600 further calculates the area in which the wide-area map is displayed on the display. The details will be described later.

The display area acquisition unit 501 acquires the displayable area of the display.

The wide-area map acquisition unit 502 acquires, from the map storage unit 5, a map with a scale equal to the value of the scale of the wide-area map calculated by the wide-area adjuster 600. The map with the scale equal to the value of the scale of the wide-area map is an example of a second map.

The wide-area route acquisition unit 503 acquires the route set by the user from the route storage unit 3 and sends it to the wide-area adjuster 600 and wide-area route generator 504a.

The wide-area route generator 504a generates the route displayed on the wide-area map. The wide-area route generator 504a generates display information that is information for displaying, on the wide-area map at the value of the scale of the wide-area map, the route from the intersection of the route with the boundary between the detailed map and the wide-area map to the destination, from the intersection of the route with the boundary between the detailed map and the wide-area map, the orientation of the displayed map associated with the area in which the detailed map is displayed on the display, the value of the scale of the wide-area map, the area in which the wide-area map is displayed on the display, and the route set by the user. The route displayed on the wide-area map is an example of a second route, and the area in which the wide-area map is displayed on the display is an example of a second area.

The wide-area display generator 505a generates display information that is information for displaying the wide-area map. The wide-area display generator 505a acquires the intersection of the route with the boundary between the detailed map and the wide-area map, the orientation of the displayed map associated with the area in which the detailed map is displayed on the display, the map with the scale equal to the value of the scale of the wide-area map, the area in which the wide-area map is displayed on the display, and the display information that is information on the route displayed on the wide-area map, and generates the display information that is information for displaying the wide-area map. In the generated display information, the route is superimposed on the wide-area map, which is provided with information on the background, including mountains, rivers, towns, or the like, information on roads, and information on trademarks or the like. The display information that is information for displaying the wide-area map is an example of second display information, and the wide-area display generator 505a is an example of a second display information generator.

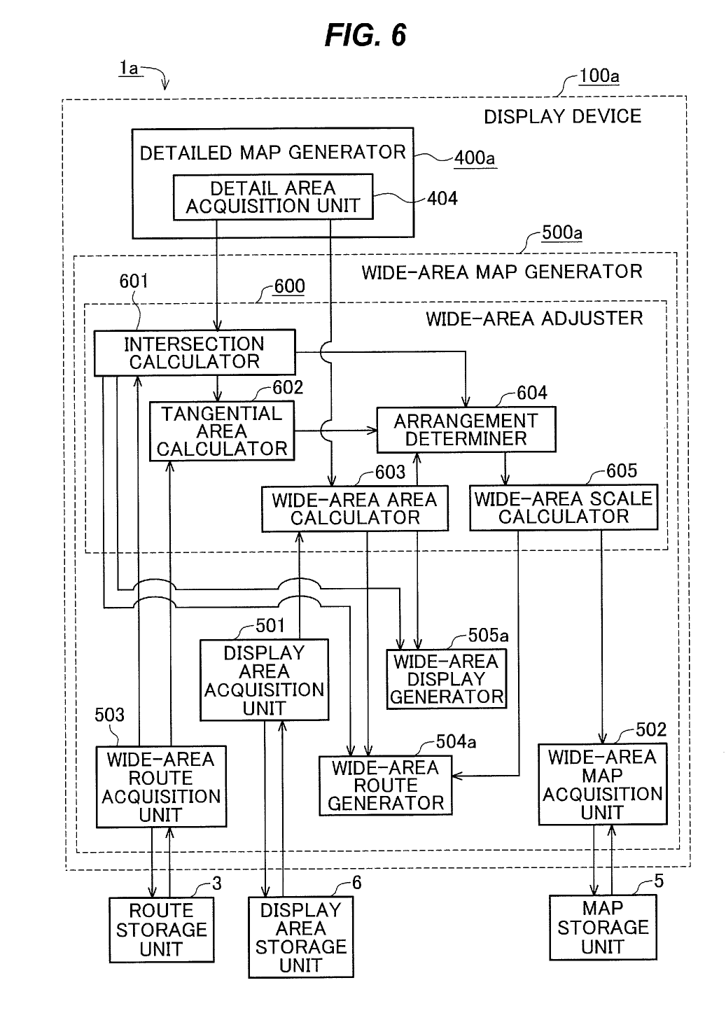

FIG. 6 is a diagram illustrating, in detail, a configuration of the wide-area adjuster 600 according to the first embodiment of the present invention. The wide-area adjuster 600 will be described in detail with reference to FIG. 6.

The wide-area adjuster 600 includes an intersection calculator 601 that calculates the intersection of the route with the boundary between the detailed map and the wide-area map, a tangential area calculator 602 that calculates an area that touches the route, a wide-area area calculator 603 that calculates the area in which the wide-area map is displayed on the display, an arrangement determiner 604 that determines whether it is an arrangement in which the entire route is included within the display, and a wide-area scale calculator 605 that calculates the value of the scale of the wide-area map.

The intersection calculator 601 calculates the intersection of the route with the boundary between the detailed map and the wide-area map. The intersection calculator 601 acquires the area in which the detailed map is displayed on the display, the orientation of the displayed map associated with the area in which the detailed map is displayed on the display, the value of the scale of the detailed map associated with the area in which the detailed map is displayed on the display, and the route set by the user, and calculates the coordinates of the intersection of the route set by the user with the boundary of the area in which the detailed map is displayed on the display in the associated orientation at the scale of the detailed map. The intersection calculator 601 may acquire, from the detail route generator 406, the display information that is information on the route set by the user within the display range of the detailed map, and calculate the coordinates of the intersection of the route set by the user with the boundary of the area in which the detailed map is displayed, from the display information that is information on the route set by the user within the display range of the detailed map and the area in which the detailed map is displayed on the display. Also, the intersection calculator 406 may acquire, from the detail display generator 407, the display information that is information for displaying the detailed map, and calculate the coordinates of the intersection of the route set by the user with the boundary of the area in which the detailed map is displayed, from the display information that is information for displaying the detailed map and the area in which the detailed map is displayed on the display.

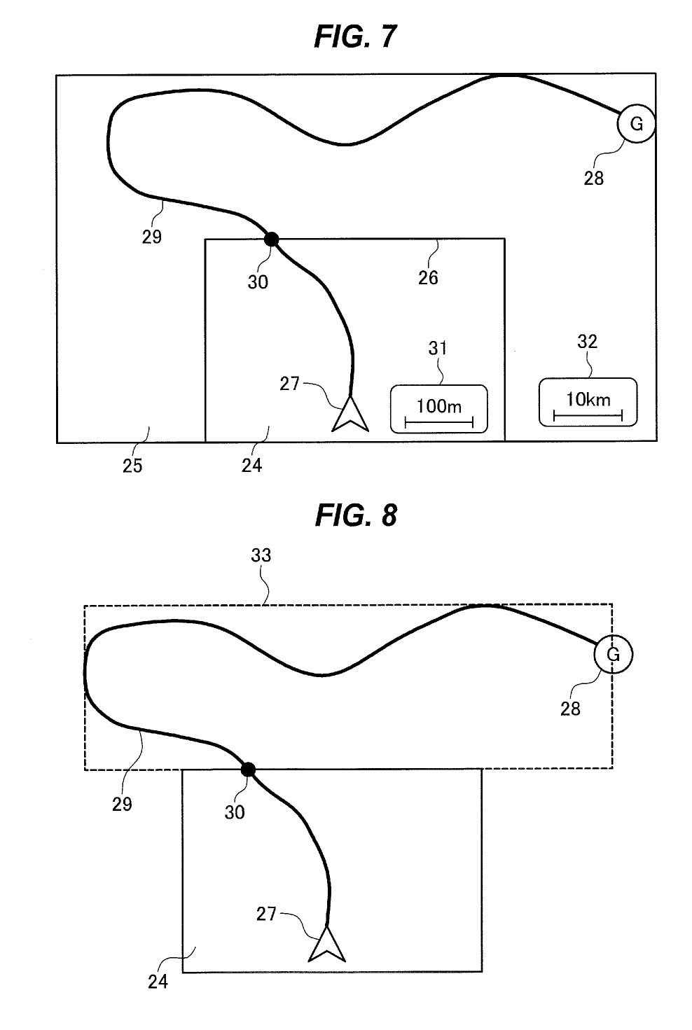

FIG. 7 is an example of display by the display according to the first embodiment. For example, the area 24 in which the detailed map is displayed on the display is rectangular as in FIG. 7, and the area 25 in which the wide-area map is displayed on the display is arranged in part of the periphery of the area 24. There is a boundary 26 between the area 24 in which the detailed map is displayed on the display and the area 25 in which the wide-area map is displayed on the display. A point at which the route 29 from the position 27 of the own vehicle to the destination 28 intersects with the boundary 26 is an intersection 30. In FIG. 7, a scale indicator 31 of the detailed map and a scale indicator 32 of the wide-area map are displayed so that the scales can be seen at a glance, but they need not necessarily be displayed. Instead of the scale indicators, grid lines may be displayed in a superimposed manner. Also in this case, the scales can be seen at a glance.

The tangential area calculator 602 calculates an area that touches the route. The tangential area calculator 602 acquires the route set by the user and the intersection of the route with the boundary between the detailed map and the wide-area map, and calculates a tangential area that touches the route from the intersection to the destination. For example, the tangential area is the smallest rectangle that touches the route from the intersection to the destination. The tangential area need not necessarily be rectangular, and may be another polygon, a circle, or the like.

FIG. 8 is a conceptual diagram for explaining the tangential area of the first embodiment. For example, it is assumed that the tangential area is rectangular. The smallest rectangle that touches the route from the intersection 30 of the route with the boundary between the detailed map and the wide-area map to the destination 28 is, for example, the area 33.

The wide-area area calculator 603 calculates the area in which the wide-area map is displayed on the display. The wide-area area calculator 603 acquires the displayable area of the display and the area in which the detailed map is displayed on the display, and calculates the area in which the wide-area map is displayed on the display.

The arrangement determiner 604 determines whether it is an arrangement in which the entire route is included within the display. The arrangement determiner 604 arranges the route in the wide-area map in such a manner that the route in the wide-area map is connected to the intersection of the route with the boundary between the detailed map and the wide-area map, in accordance with the orientation of the displayed map associated with the area in which the detailed map is displayed on the display, and determines whether the tangential area is included within the area in which the wide-area map is displayed on the display.

The wide-area scale calculator 605 calculates the value of the scale of the wide-area map. The wide-area scale calculator 605 arranges the route in the wide-area map in such a manner that the route in the wide-area map is connected to the intersection of the route with the boundary between the detailed map and the wide-area map, in accordance with the orientation of the displayed map associated with the area in which the detailed map is displayed on the display, and calculates, as the value of the scale of the wide-area map, a scale at which the tangential area is just fitted in the area in which the wide-area map is displayed on the display. It has been described that the wide-area scale calculator 605 arranges the route in the wide-area map in such a manner that the route in the wide-area map is connected to the intersection of the route with the boundary between the detailed map and the wide-area map, in accordance with the orientation of the displayed map associated with the area in which the detailed map is displayed on the display, and calculates, as the value of the scale of the wide-area map, a scale at which the tangential area is just fitted in the area in which the wide-area map is displayed on the display. However, the wide-area scale calculator 605 may determine whether the tangential area is included within the area in which the wide-area map is displayed on the display, at a scale set by the user or a previously stored scale, and if so, determine the scale set by the user or the previously stored scale as the value of the scale of the wide-area map.

Next, the operation of the display device 100a according to the first embodiment of the present invention will be described.

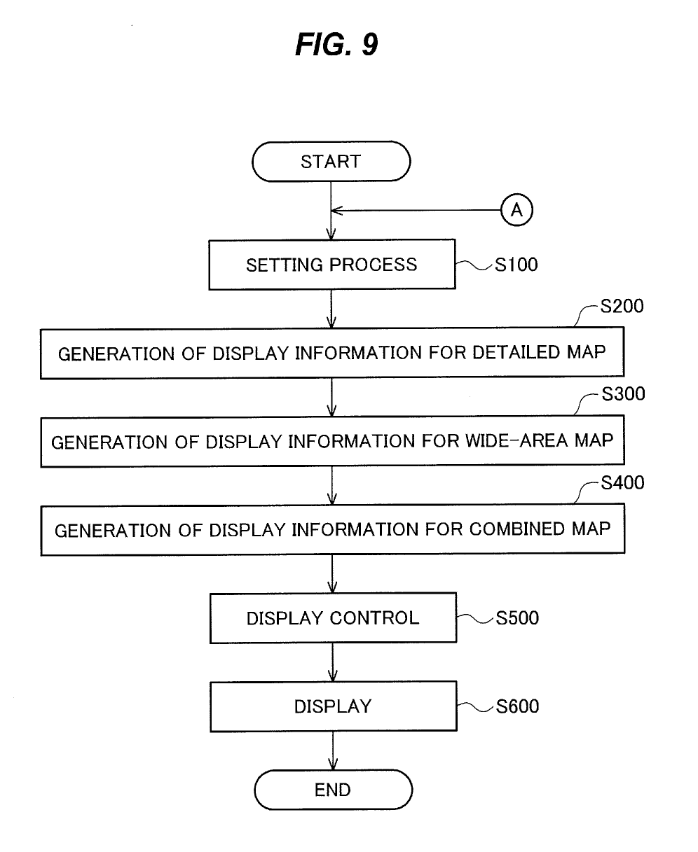

FIG. 9 is a flowchart illustrating the flow of the operation of the display device 100a according to the first embodiment of the present invention. The operation of the display device 100a will be described below with reference to FIG. 9.

In step S100, the setting processor 300 performs setting for display of the map.

In step S200, the detailed map generator 400a generates the display information for the detailed map.

In step S300, the wide-area map generator 500a generates the display information for the wide-area map.

In step S400, the map combiner 102a combines the generated detailed map and wide-area map.

In step S500, the display controller 103 performs control for causing the display unit 101 to display the combined map.

In step S600, the display unit 101 performs display according to signals sent from the display controller 103.

“A” is a process by the wide-area map generator 500a and will be described later.

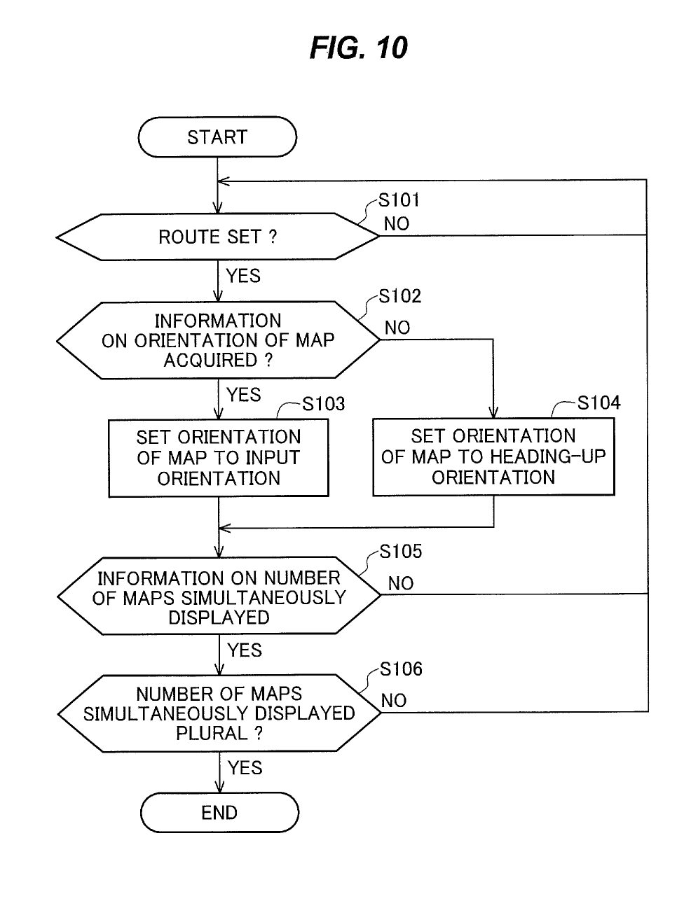

FIG. 10 is a flowchart illustrating the flow of the operation in step S100 of the setting processor 300 of the first embodiment of the present invention.

In step S101, the route setting determiner 301 determines whether the user has set a route, and determines whether to continue the display process according to the present invention. The route setting determiner 301 determines whether the user has set a route by determining whether it is possible to acquire route information set by the route storage unit 3, and determines whether to continue the display process according to the present invention. When the user has set a route, the route setting determiner 301 can acquire the route information from the route storage unit 3. When the user has set no route, the route setting determiner 301 can acquire no route information from the route storage unit 3.

When the route setting determiner 301 can acquire no route information from the route storage unit 3, it determines that the user has set no route, resulting in No in step S101. The route setting determiner 301 determines not to continue the display process according to the present invention, and returns to step S101.

When the route setting determiner 301 can acquire the route information from the route storage unit 3, it determines that the user has set a route, resulting in Yes in step S101. The route setting determiner 301 determines to continue the display process according to the present invention, and proceeds to the next step.

In step S102, the orientation setter 302 acquires the orientation of the displayed map. The orientation setter 302 determines whether it is possible to acquire the orientation of the displayed map input by the user from the input unit 8. When the orientation setter 302 can acquire the orientation of the displayed map input by the user from the input unit 8, it determines that the user has input the orientation of the displayed map into the input unit 8, resulting in Yes in step S102. In step S103, the orientation setter 302 sets the orientation of the displayed map to the orientation input by the user into the input unit 8. For example, when the user has input a north-up orientation into the input unit 8, the orientation setter 302 sets the orientation to the north-up orientation.

In step S102, when the orientation setter 302 can acquire no orientation of the displayed map input by the user from the input unit 8, it determines that the user has not input the orientation of the displayed map into the input unit 8, resulting in No in step S102. In step S104, the orientation setter 302 sets the orientation of the displayed map to the orientation stored by the setting storage unit 2. For example, when the setting storage unit 2 stores a heading-up orientation and the user has not input the orientation of the displayed map into the input unit 8, the orientation setter 302 sets the orientation of the displayed map to the heading-up orientation stored by the setting storage unit 2.

The following description describes a case where the orientation of the displayed map has been set to the heading-up orientation.

In step S105, the number setter 303 determines whether it is possible to acquire, from the input unit 8, the number of maps simultaneously displayed on the display unit 101. When the number setter 303 cannot acquire, from the input unit 8, the number of maps simultaneously displayed on the display unit 101, it determines that the user has not input the number of maps simultaneously displayed on the display unit 101 into the input unit 8, resulting in No in step S105. The number setter 303 determines that the number of maps displayed by default is one and the display process according to the present invention is not to be continued, and returns to step S101.

When the number setter 303 can acquire, from the input unit 8, the number of maps simultaneously displayed on the display unit 101, it determines that the user has input the number of maps simultaneously displayed on the display unit 101 into the input unit 8, resulting in Yes in step S105. The number setter 303 sets the number of maps simultaneously displayed on the display unit 101 to the number input by the user into the input unit 8.

In step S106, the number setter 303 determines whether the number of maps simultaneously displayed on the display unit 101 is plural. When the number input by the user into the input unit 8 is one, step S106 results in No, and the number setter 303 determines not to continue the display process according to the present invention and returns to step S101.

When the number input by the user into the input unit 8 is plural, step S106 results in Yes, and the number setter 303 determines to continue the display process according to the present invention and proceeds to the next step.

For example, when the user inputs 1 into the input unit 8 as the number of maps simultaneously displayed on the display unit 101, since the number input by the user into the input unit 8 is one, step S106 results in No, it is determined that the display process according to the present invention is not to be continued, and the process returns to step S101. When the user inputs 2 into the input unit 8 as the number of maps simultaneously displayed on the display unit 101, since the number input by the user into the input unit 8 is plural, step S106 results in Yes, it is determined that the display process according to the present invention is to be continued, and the process proceeds to the next step. The first embodiment describes a case where the user has input 2 as the number of displayed maps.

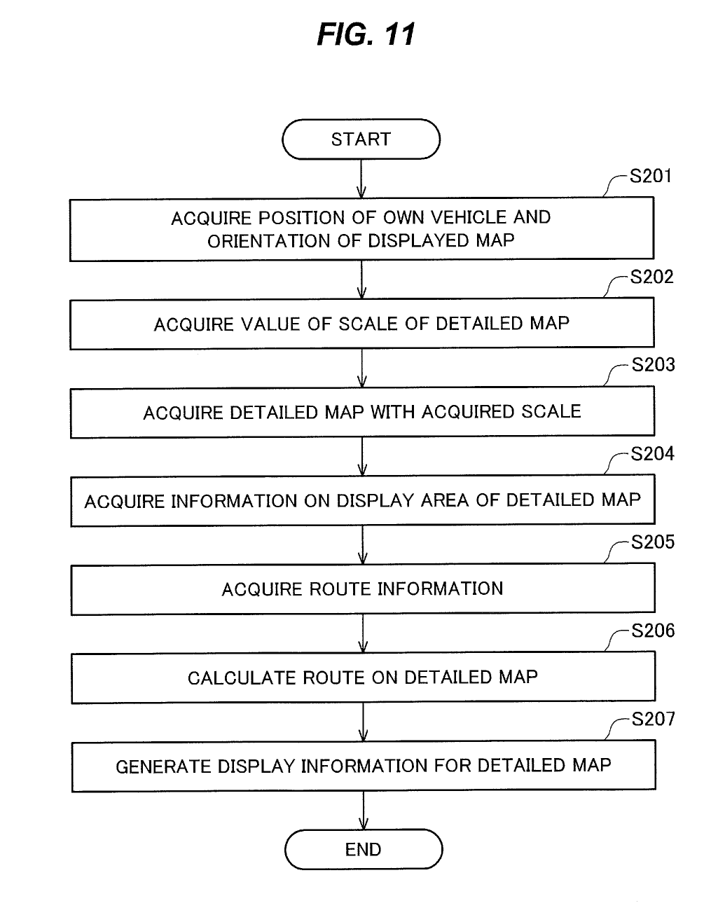

FIG. 11 is a flowchart illustrating the flow of the operation in step S200 of the detailed map generator 400a of the first embodiment of the present invention.

In step S201, the position acquisition unit 401 acquires the position of the own vehicle and the orientation of the displayed map. The position acquisition unit 401 acquires the position of the own vehicle from the position detector 4 and the heading-up orientation, which is the orientation of the displayed map, from the setting processor 300. The position acquisition unit 401 sends the heading-up orientation, which is the orientation of the displayed map, to the detail area acquisition unit 404, detail route generator 406, and detail display generator 407. The position acquisition unit 401 also sends the position of the own vehicle to the detail route generator 406 and detail display generator 407.

In step S202, the detail scale acquisition unit 402 acquires the value of the scale of the detailed map. The detail scale acquisition unit 402 acquires, for example, “ 1/100 m”, which is the value of the scale of the detailed map, from the detail scale storage unit 22, and sends “ 1/100 m”, which is the acquired value of the scale of the detailed map, to the detailed map acquisition unit 403, detail area acquisition unit 404, and detail route generator 406.

In step S203, the detailed map acquisition unit 403 acquires a detailed map with the acquired scale. The detailed map acquisition unit 403 acquires, from the map storage unit 5, a map with a scale equal to 1/100 m, which is the value of the scale of the detailed map sent by the detail scale acquisition unit 402. The detailed map acquisition unit 403 sends, to the detail display generator 407, the map with a scale of 1/100 m that has been acquired from the map storage unit 5 and is used for generating the detailed map.

In step S204, the detail area acquisition unit 404 acquires the information on the display area of the detailed map. The detail area acquisition unit 404 acquires the heading-up orientation, which is the orientation of the displayed map, from the position acquisition unit 401, acquires “ 1/100 m”, which is the value of the scale of the detailed map, from the detail scale acquisition unit 402, and acquires the area (e.g., 500×500 pixels) in which the detailed map is displayed on the display, from the detail area storage unit 23. The detail area acquisition unit 404 associates the heading-up orientation, which is the orientation of the displayed map, and “ 1/100 m”, which is the value of the scale of the detailed map, with the area (500×500 pixels) in which the detailed map is displayed on the display. The detail area acquisition unit 404 sends the area (500×500 pixels) in which the detailed map is displayed on the display that is associated with the heading-up orientation, which is the orientation of the displayed map, and “ 1/100 m”, which is the value of the scale of the detailed map, to the detail route generator 406, detail display generator 407, and wide-area map generator 500a.

In step S205, the detail route acquisition unit 405 acquires information on a route. The detail route acquisition unit 405 acquires, from the route storage unit 3, the route set by the user, and sends it to the detail route generator 406.

In step S206, the detail route generator 406 calculates the route on the detailed map. The detail route generator 406 acquires, from the position acquisition unit 401, the position of the own vehicle and the heading-up orientation, which is the orientation of the displayed map, acquires, from the detail scale acquisition unit 402, “ 1/100 m”, which is the value of the scale of the detailed map, acquires, from the detail area acquisition unit 404, the area (500×500 pixels) in which the detailed map is displayed on the display, and acquires, from the detail route acquisition unit 405, the route set by the user. The detail route generator 406 calculates a state in which the position of the own vehicle is positioned at a center of the area (500×500 pixels) in which the detailed map is displayed on the display. The detail route generator 406 calculates the display range of the detailed map from the coordinates of the position of the own vehicle by applying the value “ 1/100 m” of the scale of the detailed map in the calculated state. The detail route generator 406 generates the display information that is information on the route set by the user within the calculated display range of the detailed map, in accordance with the heading-up orientation, which is the orientation of the displayed map. The detail route generator 406 sends the generated display information that is information on the route displayed on the detailed map, to the detail display generator 407.

In the first embodiment, the detail route generator 406 calculates a state in which the position of the own vehicle is positioned at a center of the area (500×500 pixels) in which the detailed map is displayed on the display. However, the position of the own vehicle is not limited to the center, and may be at a position in the lower left of the area (500×500 pixels) in which the detailed map is displayed on the display, a position designated by the user, an easy-to-see position calculated with a formula, or other positions. Also, in the first embodiment, it is predetermined that the detail route generator 406 calculates a state in which the position of the own vehicle is positioned at a center of the area (500×500 pixels) in which the detailed map is displayed on the display, but it may be designated by the user.

In step S207, the detail display generator 407 generates the display information for the detailed map. The detail display generator 407 acquires, from the position acquisition unit 401, the position of the own vehicle and the heading-up orientation, which is the orientation of the displayed map, acquires, from the detailed map acquisition unit 403, the map with a scale of 1/100 m, which is the value of the scale of the detailed map, acquires, from the detail area acquisition unit 404, the area (500×500 pixels) in which the detailed map is displayed on the display, and acquires, from the detail route generator 406, the display information that is information on the route displayed on the detailed map. The detail display generator 407 locates the position of the own vehicle at a center of the area (500×500 pixels) in which the detailed map is displayed on the display. The detail display generator 407 locates the acquired detailed map so that the coordinates coincide with each other, in the state in which the position of the own vehicle is located at the center, in accordance with the heading-up orientation, which is the orientation of the displayed map. The detail display generator 407 superimposes the display information that is information on the route displayed on the detailed map, on the detailed map that fits within the area (500×500 pixels) in which the detailed map is displayed on the display, thereby generating the display information that is information for displaying the detailed map. The detail display generator 407 sends the display information to the map combiner 102a.

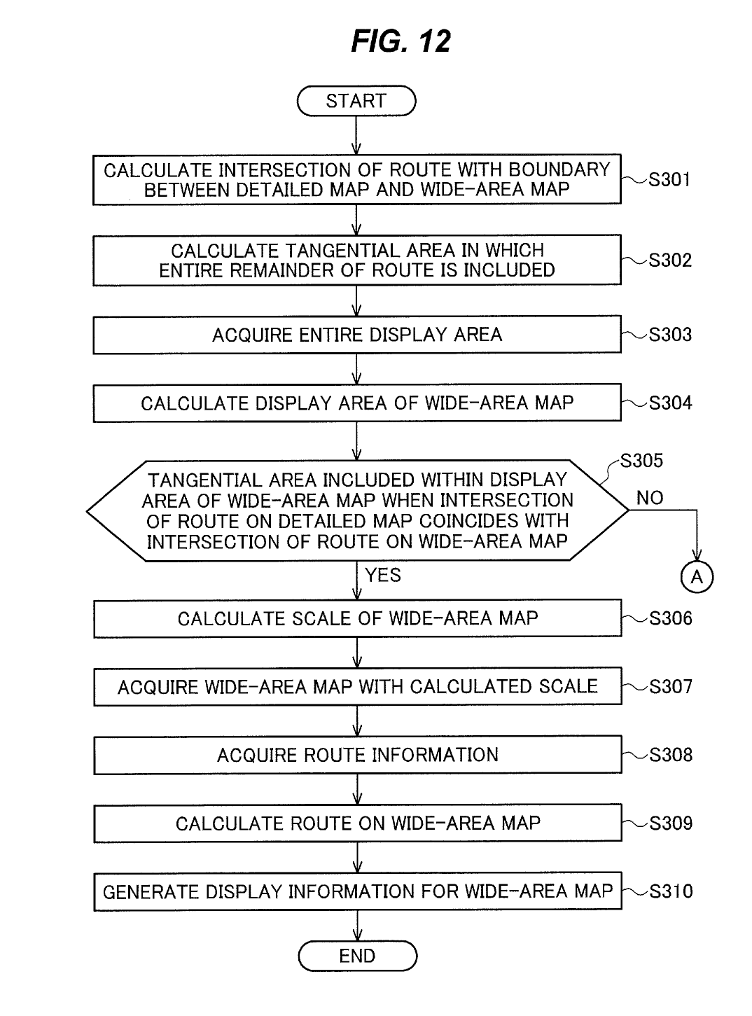

FIG. 12 is a flowchart illustrating the flow of the operation in step S300 of the wide-area map generator 500a of the first embodiment of the present invention.

In step S301, the intersection calculator 601 calculates an intersection of the route with the boundary between the detailed map and the wide-area map. The intersection calculator 601 acquires, from the detail area acquisition unit 404, the area (500×500 pixels) in which the detailed map is displayed on the display, the heading-up orientation, which is the associated orientation of the displayed map, and “ 1/100 m”, which is the value of the scale of the detailed map associated with the area in which the detailed map is displayed on the display, and acquires, from the wide-area route acquisition unit 503, the route set by the user that has been acquired from the route storage unit 3 by the wide-area route acquisition unit 503. The intersection calculator 601 calculates the coordinates of the intersection of the route set by the user with the boundary of the area in which the detailed map is displayed on the display, under the heading-up orientation and “ 1/100 m”, which is the value of the scale of the detailed map. The intersection calculator 601 sends the intersection of the route set by the user with the boundary of the area in which the detailed map is displayed on the display, to the tangential area 602, arrangement determiner 604, wide-area route generator 504a, and wide-area display generator 505a.

In step S302, the tangential area calculator 602 calculates the tangential area within which the entire remainder of the route is included. The tangential area calculator 602 acquires, from the wide-area route acquisition unit 503, the route set by the user, and acquires, from the intersection calculator 601, the intersection of the route with the boundary between the detailed map and the wide-area map. The tangential area calculator 602 calculates the route from the intersection of the route with the boundary between the detailed map and the wide-area map to the destination, and calculates the tangential area (e.g., the smallest rectangular area) that touches the calculated route from the intersection to the destination. The tangential area calculator 602 sends information on the tangential area to the arrangement determiner 604.

In step S303, the display area acquisition unit 501 acquires the displayable area of the display. The display area acquisition unit 501 acquires, from the display area storage unit 6, the displayable area (e.g., 1024×1024 pixels) of the display, and sends the acquired displayable area (1024×1024 pixels) of the display, to the wide-area area calculator 603.

In step S304, the wide-area area calculator 603 calculates the area in which the wide-area map is displayed on the display. The wide-area area calculator 603 acquires, from the display area acquisition unit 501, the displayable area (1024×1024 pixels) of the display, and acquires, from the detail area acquisition unit 404, the area (500×500 pixels) in which the detailed map is displayed on the display. The wide-area area calculator 603 calculates the area in which the wide-area map is displayed on the display and that is obtained by subtracting the area (500×500 pixels) from the area (1024×1024 pixels), by comparing the displayable area (1024×1024 pixels) of the display and the area (500×500 pixels) in which the detailed map is displayed on the display. The wide-area area calculator 603 sends the area in which the wide-area map is displayed on the display and that is obtained by subtracting the area (500×500 pixels) from the area (1024×1024 pixels), to the wide-area route generator 504a, wide-area display generator 505a, and arrangement determiner 604.

In step S305, the arrangement determiner 604 determines whether the tangential area is within the area in which the wide-area map is displayed, in a state in which the intersection of the route of the detailed map coincides with the intersection of the route of the wide-area map. The arrangement determiner 604 acquires, from the intersection calculator 601, the intersection of the route with the boundary between the detailed map and the wide-area map, and the heading-up orientation, which is the orientation of the displayed map associated with the area in which the detailed map is displayed on the display, acquires, from the tangential area calculator 602, the information on the smallest rectangular tangential area, and acquires, from the wide-area area calculator 603, the area in which the wide-area map is displayed on the display and that is obtained by subtracting the area (500×500 pixels) from the area (1024×1024 pixels). The arrangement determiner 604 arranges the route of the wide-area map in the heading-up orientation so that the route of the wide-area map is connected to the intersection of the route with the boundary between the detailed map and the wide-area map, and determines whether the smallest rectangular tangential area can be included, by scaling, within the area in which the wide-area map is displayed on the display and that is obtained by subtracting the area (500×500 pixels) from the area (1024×1024 pixels). When the smallest rectangular tangential area cannot be included within the area, step S305 results in No, and the arrangement determiner 604 determines that the present invention cannot be executed, stops the display, and returns to step S100.

When the smallest rectangular tangential area can be included within the area, step S305 results in Yes, and the arrangement determiner 604 determines that the present invention can be executed, and proceeds to the next step. The arrangement determiner 604 sends, to the wide-area scale calculator 605, the intersection of the route with the boundary between the detailed map and the wide-area map, the heading-up orientation, which is the orientation of the displayed map associated with the area in which the detailed map is displayed on the display, the information on the smallest rectangular tangential area, and the area in which the wide-area map is displayed on the display and that is obtained by subtracting the area (500×500 pixels) from the area (1024×1024 pixels).

In step S306, the wide-area scale calculator 605 calculates the value of the scale of the wide-area map. The wide-area scale calculator 605 acquires, from the arrangement determiner 604, the intersection of the route with the boundary between the detailed map and the wide-area map, the heading-up orientation, which is the orientation of the displayed map associated with the area in which the detailed map is displayed on the display, the information on the smallest rectangular tangential area, and the area in which the wide-area map is displayed on the display and that is obtained by subtracting the area (500×500 pixels) from the area (1024×1024 pixels). The wide-area scale calculator 605 arranges the route of the wide-area map in the heading-up orientation so that the route of the wide-area map is connected to the intersection of the route with the boundary between the detailed map and the wide-area map, and calculates, as the value of the scale of the wide-area map, a scale at which the smallest rectangular tangential area just fits within the area in which the wide-area map is displayed on the display and that is obtained by subtracting the area (500×500 pixels) from the area (1024×1024 pixels). In the first embodiment, it is assumed that the value of the scale of the wide-area map is calculated as 1/10 km. The wide-area scale calculator 605 sends the value “ 1/10 km” of the scale of the wide-area map to the wide-area map acquisition unit 502 and wide-area route generator 504a.

In step S307, the wide-area map acquisition unit 502 acquires a wide-area map with the calculated scale. The wide-area map acquisition unit 502 acquires, from the map storage unit 5, a map with a scale of 1/10 km, which is the value of the scale of the wide-area map calculated by the wide-area scale calculator 605. The wide-area map acquisition unit 502 sends, to the wide-area display generator 505a, the map with a scale of 1/10 km that has been acquired from the map storage unit 5 and that is used for generation of the wide-area map.

In step S308, the wide-area route generator 504a acquires the route set by the user. The wide-area route generator 504a acquires, from the wide-area adjuster 600, the intersection of the route with the boundary between the detailed map and the wide-area map, the heading-up orientation, which is the orientation of the displayed map associated with the area in which the detailed map is displayed on the display, the value “ 1/10 km” of the scale of the wide-area map, and the area in which the wide-area map is displayed on the display and that is obtained by subtracting the area (500×500 pixels) from the area (1024×1024 pixels), and acquires, from the wide-area route acquisition unit 503, the route set by the user.

In step S309, the wide-area route generator 504a calculates the route displayed on the wide-area map. The wide-area route generator 504a generates the display information that is information on the route set by the user for displaying, on the wide-area map, at the value “ 1/10 km” of the scale of the wide-area map, in the heading-up orientation, the route from the intersection of the route with the boundary between the detailed map and the wide-area map to the destination, in the area in which the wide-area map is displayed on the display and that is obtained by subtracting the area (500×500 pixels) from the area (1024×1024 pixels), in such a manner that the route is connected to the intersection of the route with the boundary between the detailed map and the wide-area map. The wide-area route generator 504a sends, to the wide-area display generator 505a, the generated display information that is information on the route displayed on the wide-area map.

In step S310, the wide-area display generator 505a generates the display information that is information for displaying the wide-area map. The wide-area display generator 505a acquires, from the wide-area adjuster 600, the intersection of the route with the boundary between the detailed map and the wide-area map, the heading-up orientation, which is the orientation of the displayed map associated with the area in which the detailed map is displayed on the display, and the area in which the wide-area map is displayed on the display and that is obtained by subtracting the area (500×500 pixels) from the area (1024×1024 pixels), and acquires, from the wide-area map acquisition unit 502, the map with a scale of 1/10 km, which is the value of the scale of the wide-area map, and acquires, from the wide-area route generator 504a, the display information that is information on the route displayed on the wide-area map. The wide-area display generator 505a arranges the wide-area map with a scale of 1/10 km and the display information that is information on the route displayed on the wide-area map, in the heading-up orientation, in the area in which the wide-area map is displayed on the display and that is obtained by subtracting the area (500×500 pixels) from the area (1024×1024 pixels), in such a manner that the route is connected to the intersection of the route with the boundary between the detailed map and the wide-area map, thereby generating the display information that is information for displaying the wide-area map. The wide-area display generator 505a sends the display information to the map combiner 102a.

As described above, in the display device 100a illustrated in this embodiment, the wide-area map generator 500a arranges the route of the wide-area map in such a manner that the route of the wide-area map is connected to the intersection of the route with the boundary between the detailed map and the wide-area map, and calculates a scale of the wide-area map such that the tangential area is included within the area in which the wide-area map is displayed on the display, and generates the wide-area map on the basis of the calculated scale. This makes it possible to display an entire route within a single screen in a continuous manner when maps with different scales are simultaneously displayed on the same screen. Thus, even when the maps with the different scales are simultaneously displayed on the same screen, the entire route can be seen at a glance.

In the above display device 100a illustrated in this embodiment, the wide-area map generator 500a arranges the route of the wide-area map in such a manner that the route of the wide-area map is connected to the intersection of the route with the boundary between the detailed map and the wide-area map, and calculates a scale of the wide-area map such that the tangential area is included within the area in which the wide-area map is displayed on the display, and generates the wide-area map on the basis of the calculated scale. However, it is possible that the wide-area map is generated first, and the detailed map generator 400a arranges the route of the detailed map in such a manner that the route of the detailed map is connected to the intersection of the route with the boundary between the detailed map and the wide-area map, and calculates a scale of the detailed map such that the tangential area is included within the area in which the detailed map is displayed on the display, and generates the detailed map on the basis of the calculated scale. A display device configured in this manner can also provide the above advantages of the first embodiment.

In the above display device 100a illustrated in this embodiment, the position of the own vehicle is acquired, but a starting point, a position designated by the user, or the like may be acquired. Also, in the above description, the end of the route is the destination, but it may be a position designated by the user, a transit point, the closest search result, or the like, or may be a point where attention is required in running, such as a point where the road is sharply curved or narrowed, a point where accidents frequently occur, a point under construction, or the like. A display device configured in this manner can display the entire route in a certain section and provide the above advantages of the first embodiment.

The above display device 100a illustrated in this embodiment calculates the scale of the wide-area map from the detailed map, but it is also possible to calculate the scale of the detailed map from the wide-area map. A display device configured in this manner can also provide the above advantages of the first embodiment.

The above display device 100a illustrated in this embodiment uses a map including the position of the own vehicle as the detailed map and a map including the destination as the wide-area map, but it is also possible to use a map including the position of the own vehicle as the wide-area map and a map including the destination as the detailed map. A display device configured in this manner can also provide the above advantages of the first embodiment.

The above display device 100a illustrated in this embodiment arranges the detailed map at the lower center of the wide-area map in the display, but it is also possible to arrange the detailed map at the center, lower right, or the like of the wide-area map. The arrangement of the detailed map is determined from the relationship between the position of the own vehicle, the destination, and the orientation of the displayed map. A display device configured in this manner can also provide the above advantages of the first embodiment.

In the above display device 100a illustrated in this embodiment, the tangential area calculator 602 calculates the tangential area that touches the route from the intersection of the route with the boundary between the detailed map and the wide-area map to the coordinates of the destination. However, it is also possible to set, for example, a circular region centered at the destination and surrounding 20 m as a predetermined region, and calculate a tangential area that touches the route from the intersection of the route with the boundary between the detailed map and the wide-area map to the region of the destination. When the tangential area calculator 602 takes coordinates as the destination, the destination can be located on the boundary of the tangential area. However, when the tangential area calculator 602 takes a predetermined region as the destination, the destination is not located on the boundary of the tangential area, and thus is easy to see. A display device configured in this manner prevents the destination from being displayed on the boundary of display of the display, thereby improving visibility, in addition to the above advantages of the first embodiment. The predetermined region surrounding the destination may be a rectangular region, instead of a circular region. The destination may be located at a position displaced from the center in a direction, instead of the center.

In the above display device 100a illustrated in this embodiment, the display device 100a is applied to a car navigation system, but this is not mandatory. The display device 100a is applicable to mobile terminals, mobile phones, desktop terminals, and any display devices that display maps on screens on the basis of map data. Display devices configured in this manner can also provide the above advantages of the first embodiment.

### Second Embodiment

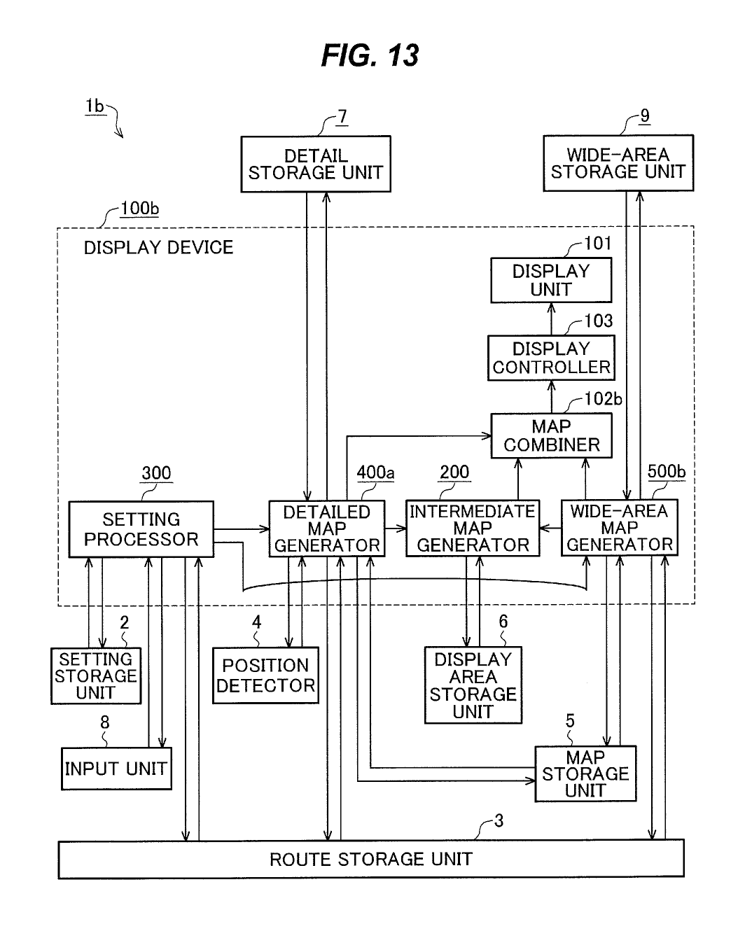

The first embodiment generates the wide-area map such that the wide-area map entirely includes the route from the detailed map. A display device 100b of a second embodiment differs in having an intermediate map generator 200 that provides an intermediate map connecting the detailed map and the wide-area map in addition to the detailed map and wide-area map, as illustrated in FIGS. 13 to 19. The intermediate map generator 200 connects an intersection of a route with a boundary between the detailed map and the intermediate map and an intersection of the route with a boundary between the wide-area map and the intermediate map, with a straight line, a curved line, or the like, in a deformed manner, in the area in which the intermediate map is displayed. With the provision of the intermediate map generator 200, a wide-area map generator 500b is different in configuration from that of the first embodiment. Otherwise, the display device 100b is the same as that of the first embodiment. This configuration makes it possible to fix the scales of the areas in which the detailed map and wide-area map are displayed even when the own vehicle is running, and reduce flicker of the maps due to change in the scales, in addition to the advantages of the first embodiment. Further, it is possible to fix the areas in which the detailed map and wide-area map are displayed even when the own vehicle is running, and reduce flicker of the maps due to change in the areas. In the following description, parts and steps that have already been described will be given the same reference characters, and duplicate descriptions thereof will be omitted.

FIG. 13 is a diagram illustrating a configuration of a car navigation system 1b including the display device 100b according to the second embodiment.

A wide-area storage unit 9 stores setting for displaying the wide-area map. The detail will be described later. The wide-area map is an example of a second map.

The display device 100b simultaneously displays maps with different scales on the same screen and displays an entire route within the single screen in a continuous manner. Further, it provides the intermediate map in addition to the detailed map and wide-area map. The display device 100b includes the wide-area map generator 500b that generates the wide-area map, the intermediate map generator 200 that generates the intermediate map, and a map combiner 102b that combines the generated detailed map, wide-area map, and intermediate map. Otherwise, the display device 100b is the same as that of the first embodiment. However, the number setter 303 of the setting processor 300 sends the orientation of the displayed map not only to the detailed map generator 400a but also to the wide-area map generator 500b. The detail area acquisition unit 404 of the detailed map generator 400a sends the orientation of the displayed map and the value of the scale of the detailed map associated with the area in which the detailed map is displayed on the display, to the intermediate map generator 200 instead of the wide-area map generator 500a. The wide-area map generator 500b and the intermediate map generator 200 that generates the intermediate map will be described in detail later. As in the first embodiment, the area in which the detailed map is displayed is an example of a first area, the position of the own vehicle is an example of a first position, the route displayed on the detailed map is an example of a first route, the detailed map is an example of a first map, the display information that is information for displaying the detailed map is an example of first display information, the detail display generator 407 is an example of a first display information generator, and the route set by the user is an example of an entire route.

The map combiner 102b combines the detailed map generated by the detailed map generator 400a, the wide-area map generated by the wide-area map generator 500b, and the intermediate map generated by the intermediate map generator 200. For example, each of the detailed map, wide-area map, and intermediate map is associated with where and how widely the map is to be displayed on the display, and the detailed map, wide-area map, and intermediate map are combined according to them.

It has been described that the display controller 103 determines a coordinate transformation matrix for the combined map, converts it into a signal that can be transmitted to the display unit 101 and read by the display unit 101, and sends the signal to the display unit 101. However, determining a coordinate transformation matrix for the combined map and converting it into a signal that can be transmitted to the display unit 101 and read by the display unit 101 may be performed by each of the detailed map generator 400a, wide-area map generator 500b, and intermediate map generator 200, or may be performed by the map combiner 102b or the like.

The hardware configuration of the car navigation system 1b including the display device 100b according to the second embodiment of the present invention is the same as that of FIG. 2. The configuration of the car navigation system 1b including the display device 100b according to the second embodiment of the present invention will be described with reference to FIG. 2, wherein only parts different from those of the first embodiment will be described.

In the second embodiment, the car navigation system 1b including the display device 100b is a computer. The car navigation system 1b includes hardware components: a bus 11 that is a signal path, an input interface 12 that is a device for input by the user, a sensor 13 that detects the position of the own vehicle, a GPS receiver 14 that receives GPS data, a main memory 15 that is a work area, an external storage device 16 that stores programs, maps, or the like, a processor 17 that reads and executes the programs of the external storage device 16 that have been loaded into the main memory 15, and a display 18 that displays results from the respective devices. The display device 100b is implemented by part of the processor 17 and the display 18.

The external storage device 16 implements the wide-area storage unit 9 in addition to the first embodiment.

Although it has been described that the wide-area storage unit 9 is implemented by the external storage device 16, it may be implemented by the main memory 15 or processor 17.

The processor 17 reads and executes programs of the external storage device 16 loaded into the main memory 15, thereby implementing the wide-area map generator 500b, intermediate map generator 200, and map combiner 102b.

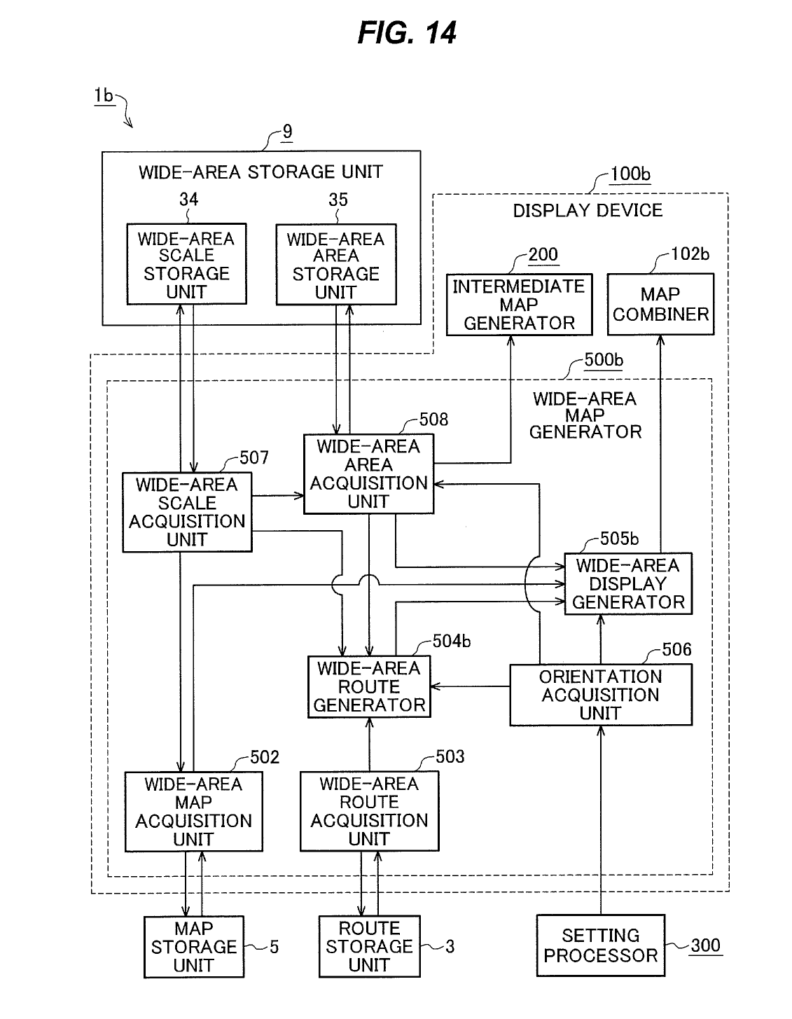

FIG. 14 is a diagram illustrating, in detail, a configuration of the wide-area map generator 500b according to the second embodiment of the present invention. The wide-area storage unit 9 and wide-area map generator 500b will be described in detail with reference to FIG. 14.

The wide-area storage unit 9 includes a wide-area scale storage unit 34 that stores the value of the scale of the wide-area map, and a wide-area area storage unit 35 that stores the area in which the wide-area map is displayed on the display. The wide-area map generator 500b includes an orientation acquisition unit 506 that acquires the orientation of the displayed map, a wide-area scale acquisition unit 507 that acquires the value of the scale of the wide-area map, a wide-area area acquisition unit 508 that acquires the area in which the wide-area map is displayed on the display, a wide-area route generator 504b that generates the route displayed on the wide-area map, and a wide-area display generator 505b that generates display information that is information for displaying the wide-area map. Otherwise, the wide-area map generator 500b is the same as that of the first embodiment.

However, the wide-area map acquisition unit 502, which acquires a map used for generation of the wide-area map, acquires, from the map storage unit 5, a map with a scale equal to the value of the scale of the wide-area map acquired by the wide-area scale acquisition unit 507, instead of acquiring, from the map storage unit 5, a map with a scale equal to the value of the scale of the wide-area map calculated by the wide-area adjuster 600.

The wide-area route acquisition unit 503, which acquires the route set by the user, acquires, from the route storage unit 3, not only the route set by the user but also the destination. The wide-area route acquisition unit 503 does not send the route and destination set by the user to the wide-area adjuster 600, and sends it only to the wide-area route generator 504b. The destination is an example of a second position.

The wide-area scale storage unit 34 stores the value of the scale of the wide-area map. In the second embodiment, the scale of the wide-area map is a stored given value, but it may be a value input by the user or a calculated value. Here, when the scale of the wide-area map is calculated, it is determined so that the smallest rectangle that touches the route from the position of the own vehicle to the destination set by the user is included within a rectangle of the outline of the area in which the wide-area map is displayed on the display. When the scale of the wide-area map is a stored given value, a value input by the user, or a calculated value, a limitation is set so that the scale is not larger than a scale at which the smallest rectangle that touches the route set by the user from the position of the own vehicle to the destination is included within the rectangle of the outline of the area in which the wide-area map is displayed on the display.

The wide-area area storage unit 35 stores the area in which the wide-area map is displayed on the display. In the second embodiment, the area in which the wide-area map is displayed on the display is a stored given value, but it may be a value input by the user, a calculated value, or the like. The area in which the wide-area map is displayed on the display is an example of a second area.

The orientation acquisition unit 506 acquires, from the setting processor 300, the orientation of the displayed map set by the setting processor 300.

The wide-area scale acquisition unit 507 acquires, from the wide-area scale storage unit 34, the value of the scale of the wide-area map.

The wide-area area acquisition unit 508 acquires, from the wide-area area storage unit 35, the area in which the wide-area map is displayed on the display. Also, the wide-area area acquisition unit 508 acquires the orientation of the displayed map from the orientation acquisition unit 506 and the value of the scale of the wide-area map from the wide-area scale acquisition unit 507, and associates them with the area in which the wide-area map is displayed on the display.

The wide-area route generator 504b generates the route displayed on the wide-area map. The wide-area route generator 504b generates display information that is information on the route set by the user within the display range of the wide-area map, from the destination, the orientation of the displayed map, the value of the scale of the wide-area map, the area in which the wide-area map is displayed on the display, and the route set by the user. The route displayed on the wide-area map is an example of a second route.

The wide-area display generator 505b generates display information that is information for displaying the wide-area map. The wide-area display generator 505b acquires the destination, the orientation of the displayed map, the map with a scale equal to the value of the scale of the wide-area map, the area in which the wide-area map is displayed on the display, and the display information that is information on the route displayed on the wide-area map, and generates the display information that is information for displaying the wide-area map. In the generated display information, the route and destination are superimposed on the wide-area map, which is provided with information on the background, including mountains, rivers, towns, or the like, information on roads, and information on trademarks or the like. The display information that is information for displaying the wide-area map is an example of second display information, and the wide-area display generator 505b is an example of a second display information generator.

The wide-area route generator 504b may locate the destination anywhere as long as the route from the destination to the intersection with the boundary between the wide-area map and the intermediate map is included within the area in which the wide-area map is displayed on the display. In the second embodiment, the wide-area route generator 504b initially locates the destination at an upper center of the display, and if the route from the destination to the intersection with the boundary between the wide-area map and the intermediate map is not included within the area in which the wide-area map is displayed on the display, translates it so that the route is included within the area. The wide-area display generator 505b generates the wide-area map on the basis of the position of the destination set by the wide-area route generator 504b. In the second embodiment, the wide-area route generator 504b initially locates the destination at an upper center of the display, and if the route from the destination to the intersection with the boundary between the wide-area map and the intermediate map is not included within the area in which the wide-area map is displayed on the display, translates it so that the route is included within the area. However, the initial location may be set by the user. The user may set it so that the route is included within the area while viewing the map. If the route is not included within the area when the destination is initially located, the display may be stopped, or the scale may be changed so that the route is included within the area, or it may be calculated in the same way as the arrangement of the wide-area map in the first embodiment. Further, although it has been described that the wide-area route generator 504b locates the destination, it is also possible that the wide-area display generator 505b locates the destination and sends information on the location of the destination to the wide-area route generator 504b.

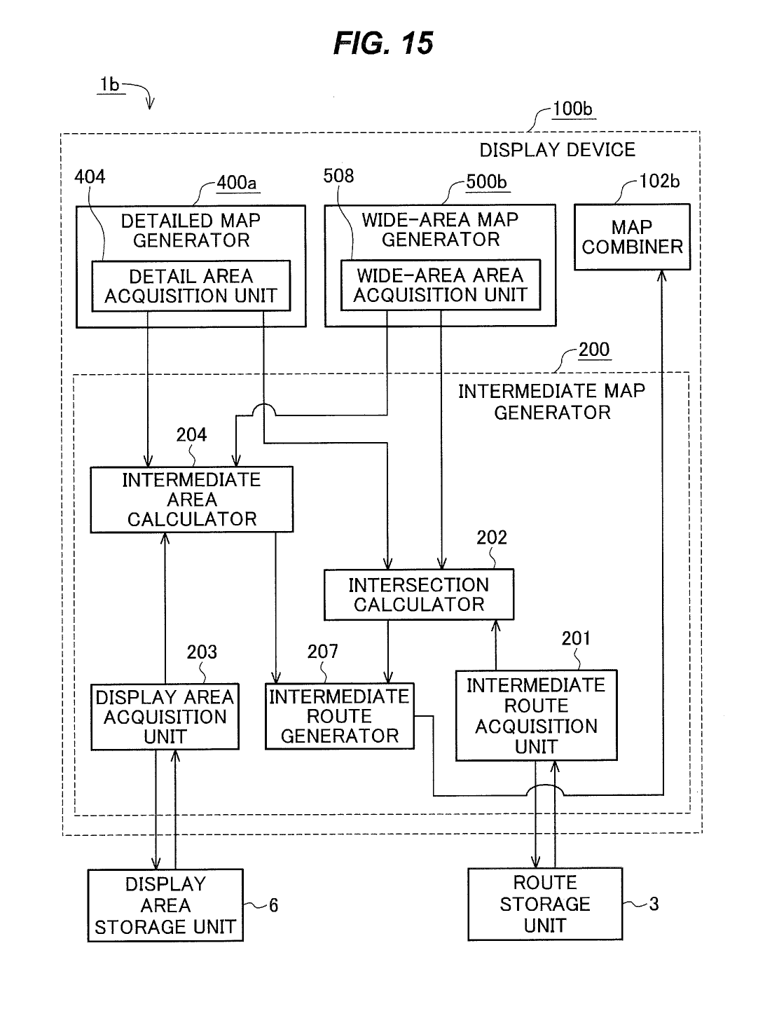

FIG. 15 is a diagram illustrating, in detail, a configuration of the intermediate map generator 200 according to the second embodiment of the present invention. The intermediate map generator 200 will be described in detail with reference to FIG. 15.

The intermediate map generator 200 includes an intermediate route acquisition unit 201 that acquires the route set by the user, an intersection calculator 202 that calculates an intersection of the route with the boundary between the detailed map and the intermediate map and an intersection of the route with the boundary between the wide-area map and the intermediate map, a display area acquisition unit 203 that acquires the displayable area of the display, an intermediate area calculator 204 that acquires the area in which the intermediate map is displayed on the display, and an intermediate route generator 207 that generates a route displayed on the intermediate map.

The intermediate route acquisition unit 201 acquires the route set by the user from the route storage unit 3, and sends it to the intersection calculator 202.

The intersection calculator 202 calculates the intersection of the route with the boundary between the detailed map and the intermediate map. The intersection calculator 202 acquires the area in which the detailed map is displayed on the display, the orientation of the displayed map associated with the area in which the detailed map is displayed on the display, the value of the scale of the detailed map associated with the area in which the detailed map is displayed on the display, and the route set by the user, and calculates the coordinates of the intersection of the route set by the user with the boundary of the area in which the detailed map is displayed on the display in the associated orientation at the associated scale of the detailed map. The intersection of the route with the boundary between the detailed map and the intermediate map is an example of a first intersection. The intersection calculator 202 may acquire, from the detail route generator 406, the display information that is information on the route set by the user within the display range of the detailed map, and calculate the coordinates of the intersection of the route set by the user with the boundary of the area in which the detailed map is displayed, from the display information that is information on the route set by the user within the display range of the detailed map and the area in which the detailed map is displayed on the display. Also, the intersection calculator 202 may acquire, from the detail display generator 407, the display information that is information for displaying the detailed map, and calculate the coordinates of the intersection of the route set by the user with the boundary of the area in which the detailed map is displayed, from the display information that is information for displaying the detailed map and the area in which the detailed map is displayed on the display.

The intersection calculator 202 also calculates the intersection of the route with the boundary between the wide-area map and the intermediate map. The intersection calculator 202 acquires the area in which the wide-area map is displayed on the display, the orientation of the displayed map associated with the area in which the wide-area map is displayed on the display, the value of the scale of the wide-area map associated with the area in which the wide-area map is displayed on the display, and the route set by the user, and calculates the coordinates of the intersection of the route set by the user with the boundary of the area in which the wide-area map is displayed on the display in the associated orientation at the associated scale of the wide-area map. The intersection of the route with the boundary between the wide-area map and the intermediate map is an example of a second intersection. The intersection calculator 202 may acquire, from the wide-area route generator 504b, the display information that is information on the route set by the user within the display range of the wide-area map, and calculate the coordinates of the intersection of the route set by the user with the boundary of the area in which the wide-area map is displayed, from the display information that is information on the route set by the user within the display range of the wide-area map and the area in which the wide-area map is displayed on the display. Also, the intersection calculator 202 may acquire, from the wide-area display generator 505b, the display information that is information for displaying the wide-area map, and calculate the coordinates of the intersection of the route set by the user with the boundary of the area in which the wide-area map is displayed, from the display information that is information for displaying the wide-area map and the area in which the wide-area map is displayed on the display.

The display area acquisition unit 203 acquires the displayable area of the display. The displayable area of the display is an example of an entire area.

The intermediate area calculator 204 calculates the area in which the intermediate map is displayed on the display. The intermediate area calculator 204 acquires the displayable area of the display and the areas in which the detailed map and wide-area map are displayed on the display, and calculates the area in which the intermediate map is displayed on the display. The area in which the intermediate map is displayed on the display is an example of a third area.

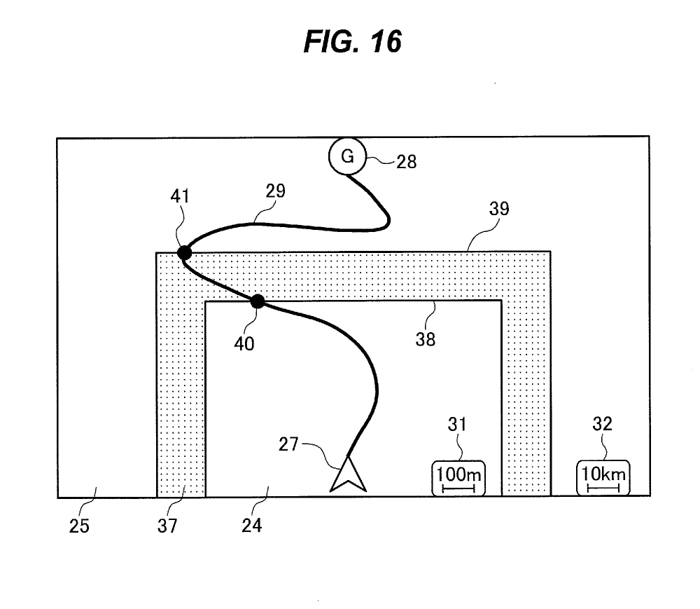

FIG. 16 is an example of display by the display according to the second embodiment. For example, the area in which the intermediate map is displayed on the display is set to the area 37 in which the intermediate map is displayed on the display as in FIG. 16. There is a boundary 38 between the area 24 in which the detailed map is displayed on the display and the area 37 in which the intermediate map is displayed on the display. There is a boundary 39 between the area 25 in which the wide-area map is displayed on the display and the area 37 in which the intermediate map is displayed on the display. A point at which the route 29 from the position 27 of the own vehicle to the destination 28 intersects with the boundary 38 is an intersection 40. A point at which the route 29 from the position 27 of the own vehicle to the destination 28 intersects with the boundary 39 is an intersection 41. In FIG. 16, a scale indicator 31 of the detailed map and a scale indicator 32 of the wide-area map are displayed so that the scales can be seen at a glance, but they need not necessarily be displayed. Instead of the scale indicators, grid lines may be displayed in a superimposed manner. Also in this case, the scales can be seen at a glance. The intermediate map is a map connecting the routes with a straight line, a curved line, or the like in a deformed manner, so it is difficult to indicate its scale. Thus, in the second embodiment, no scale indicator is displayed. However, for example, when the scale is constant or varies in stages and thus the scale indicator can be displayed, the scale indicator may be displayed. Further, although in the second embodiment, the display is performed in the heading-up orientation, the orientation of the intermediate map is not the heading-up orientation, and the area is distorted. In the second embodiment, to indicate the mismatch between the orientations, the area 37 in which the intermediate map is displayed on the display is hatched. However, the hatching is not mandatory. Also, instead of hatching, a mark, a note, or the like may be displayed.

The intermediate route generator 207 generates the route displayed on the intermediate map. From the intersection of the route with the boundary between the detailed map and the intermediate map, the intersection of the route with the boundary between the wide-area map and the intermediate map, and the area in which the intermediate map is displayed on the display, the intermediate route generator 207 generates display information that is information on the route that is displayed on the intermediate map, connects the intersection of the route with the boundary between the detailed map and the intermediate map and the intersection of the route with the boundary between the wide-area map and the intermediate map with a straight line, a curved line, or the like in a deformed manner, and is included within the area in which the intermediate map is displayed. The display information that is information on the route displayed on the intermediate map is display information for the intermediate map. Here, the display information that is information on the route displayed on the intermediate map is an example of third display information, and the intermediate route generator 207 is an example of a third display information generator.

The intermediate route generator 207 may acquire the route set by the user from the route storage unit 3, and deform and connect the route set by the user between the intersection of the route with the boundary between the detailed map and the intermediate map and the intersection of the route with the boundary between the wide-area map and the intermediate map.

Next, the operation of the display device 100b according to the second embodiment of the present invention will be described.

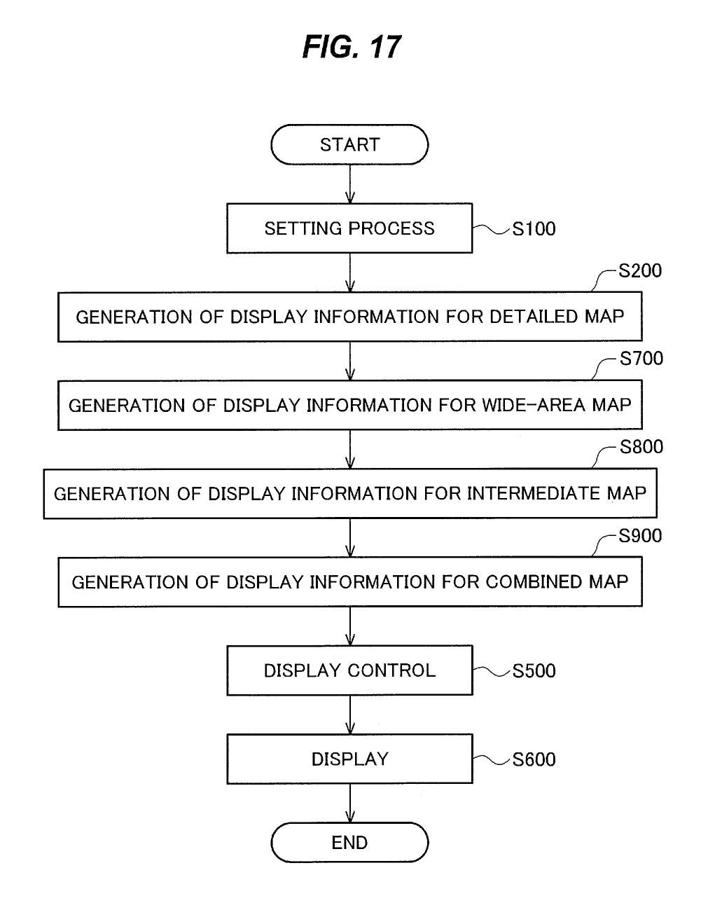

FIG. 17 is a flowchart illustrating the flow of the operation of the display device 100b according to the second embodiment of the present invention. The operation of the display device 100b will be described below with reference to FIG. 17. In the following description, steps that have already been described will be given the same reference characters, and duplicate descriptions thereof will be omitted.

Steps S100, S200, S500, and S600 are the same as steps S100, S200, S500, and S600 of the first embodiment, so only steps S700 to S900 will be described. However, in the processes in steps S100 and S200, the number setter 303 of the setting processor 300 sends the orientation of the displayed map not only to the detailed map generator 400a but also to the wide-area map generator 500b. Also, the detail area acquisition unit 404 of the detailed map generator 400a sends the orientation of the displayed map and the value of the scale of the detailed map that are associated with the area in which the detailed map is displayed on the display, to the intermediate map generator 200 instead of the wide-area map generator 500a.

In step S700, the wide-area map generator 500b generates the display information for the wide-area map.

In step S800, the intermediate map generator 200 generates the display information for the intermediate map.

In step S900, the map combiner 102b combines the generated detailed map, wide-area map, and intermediate map, and generates display information for the combined map.

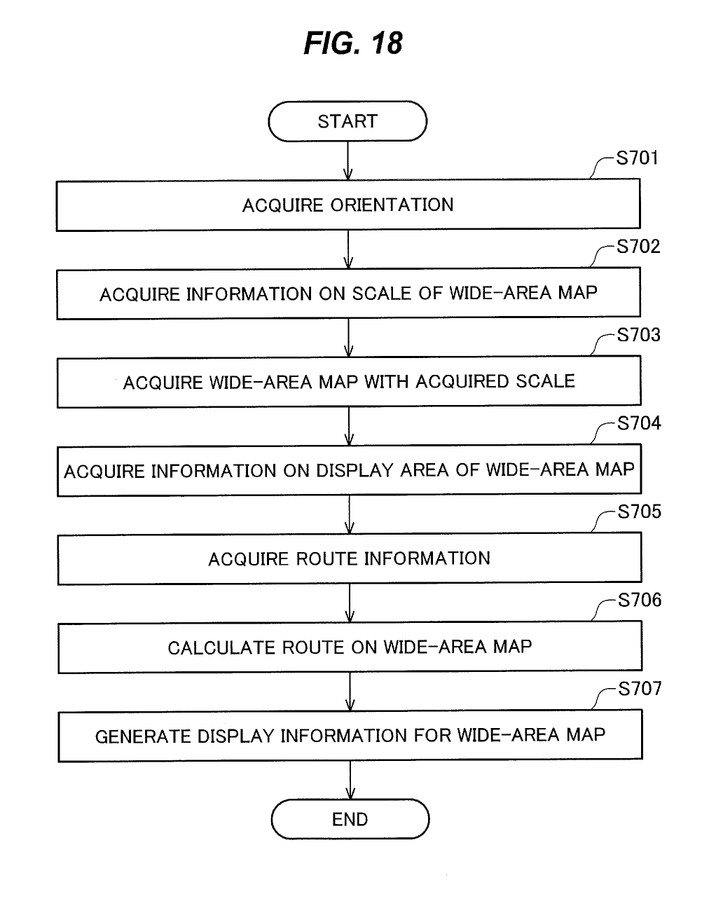

FIG. 18 is a flowchart illustrating the flow of the operation in step S700 of the wide-area map generator 500b of the second embodiment of the present invention.

In step S701, the orientation acquisition unit 506 acquires the orientation of the displayed map. The orientation acquisition unit 506 acquires, from the setting processor 300, the heading-up orientation, which is the orientation of the displayed map, set by the setting processor 300. The orientation acquisition unit 506 sends the heading-up orientation, which is the orientation of the displayed map, to the wide-area area acquisition unit 508, wide-area route generator 504b, and wide-area display generator 505b.

In step S702, the wide-area scale acquisition unit 507 acquires the value of the scale of the wide-area map. The wide-area scale acquisition unit 507 acquires, for example, “ 1/10 km”, which is the value of the scale of the wide-area map, from the wide-area scale storage unit 34, and sends “ 1/10 km”, which is the acquired value of the scale of the wide-area map, to the wide-area map acquisition unit 502, wide-area route generator 504b, and wide-area area acquisition unit 508.

In step S703, the wide-area map acquisition unit 502 acquires the wide-area map with the acquired scale. The wide-area map acquisition unit 502 acquires, from the map storage unit 5, a map with a scale of 1/10 km, which is the value of the scale of the wide-area map sent by the wide-area scale acquisition unit 507. The wide-area map acquisition unit 502 sends, to the wide-area display generator 505b, the map with a scale of 1/10 km that has been acquired from the map storage unit 5 and is used for generation of the wide-area map.

In step S704, the wide-area area acquisition unit 508 acquires the area in which the wide-area map is displayed on the display. The wide-area area acquisition unit 508 acquires the heading-up orientation, which is the orientation of the displayed map, from the orientation acquisition unit 506 and “ 1/10 km”, which is the value of the scale of the wide-area map, from the wide-area scale acquisition unit 507, and acquires, for example, the area in which the wide-area map is displayed on the display, from the wide-area area storage unit 35. Here, the size of the area in which the wide-area map is displayed on the display can be obtained as the number of pixels, and the shape of the area is, in the second embodiment, a shape like the area 25 of FIG. 16 in which the wide-area map is displayed. Although in the second embodiment, the area in which the wide-area map is displayed has a shape like the area 25 of FIG. 16 in which the wide-area map is displayed, it may have any shape. The wide-area area acquisition unit 508 associates the heading-up orientation, which is the orientation of the displayed map, and “ 1/10 km”, which is the value of the scale of the wide-area map, with the area in which the wide-area map is displayed on the display. The wide-area area acquisition unit 508 sends the area in which the wide-area map is displayed on the display and that is associated with the heading-up orientation, which is the orientation of the displayed map, and “ 1/10 km”, which is the value of the scale of the wide-area map, to the wide-area route generator 504b, wide-area display generator 505b, and intermediate map generator 200.

In step S705, the wide-area route acquisition unit 503 acquires the route set by the user. The wide-area route acquisition unit 503 acquires, from the route storage unit 3, the route set by the user and the coordinates of the destination, and sends them to the wide-area route generator 504b.

In step S706, the wide-area route generator 504b calculates the route displayed on the wide-area map. The wide-area route generator 504b acquires the heading-up orientation, which is the orientation of the displayed map, from the orientation acquisition unit 506, acquires “ 1/10 km”, which is the value of the scale of the wide-area map, from the wide-area scale acquisition unit 507, acquires, from the wide-area area acquisition unit 508, the area in which the wide-area map is displayed on the display, and acquires, from the wide-area route acquisition unit 503, the route set by the user and the coordinates of the destination. The wide-area route generator 504b calculates a state in which the destination is located at an upper center of the display. The wide-area route generator 504b calculates the display range of the wide-area map from the coordinates of the destination by applying the value “ 1/10 km” of the scale of the wide-area map in the calculated state. The wide-area route generator 504b generates the display information that is information on the route set by the user within the calculated display range of the wide-area map, in accordance with the heading-up orientation, which is the orientation of the displayed map. The wide-area route generator 504b sends the generated display information that is information on the route displayed on the wide-area map, to the wide-area display generator 505b. In the second embodiment, it is assumed that the route from the destination to the intersection with the boundary between the wide-area map and the intermediate map has been included within the area in which the wide-area map is displayed on the display.

In step S707, the wide-area display generator 505b generates the display information that is information for displaying the wide-area map. The wide-area display generator 505b acquires, the heading-up orientation, which is the orientation of the displayed map, from the orientation acquisition unit 506, acquires the map with a scale of 1/10 km, which is the value of the scale of the wide-area map, from the wide-area map acquisition unit 502, acquires the area in which the wide-area map is displayed on the display, from the wide-area area acquisition unit 508, and acquires the display information that is information on the route displayed on the wide-area map, from the wide-area route generator 504b. The wide-area display generator 505b locates the destination at an upper center of the area in which the wide-area map is displayed on the display. The wide-area display generator 505b locates the acquired wide-area map so that the coordinates coincide with each other, in the state in which the destination is located at the upper center of the area in which the wide-area map is displayed on the display, in accordance with the heading-up orientation, which is the orientation of the displayed map. The wide-area display generator 505b superimposes the display information that is information on the route displayed on the wide-area map, on the wide-area map that fits within the area in which the wide-area map is displayed on the display, thereby generating the display information that is information for displaying the wide-area map. The wide-area display generator 505b sends the display information to the map combiner 102b.

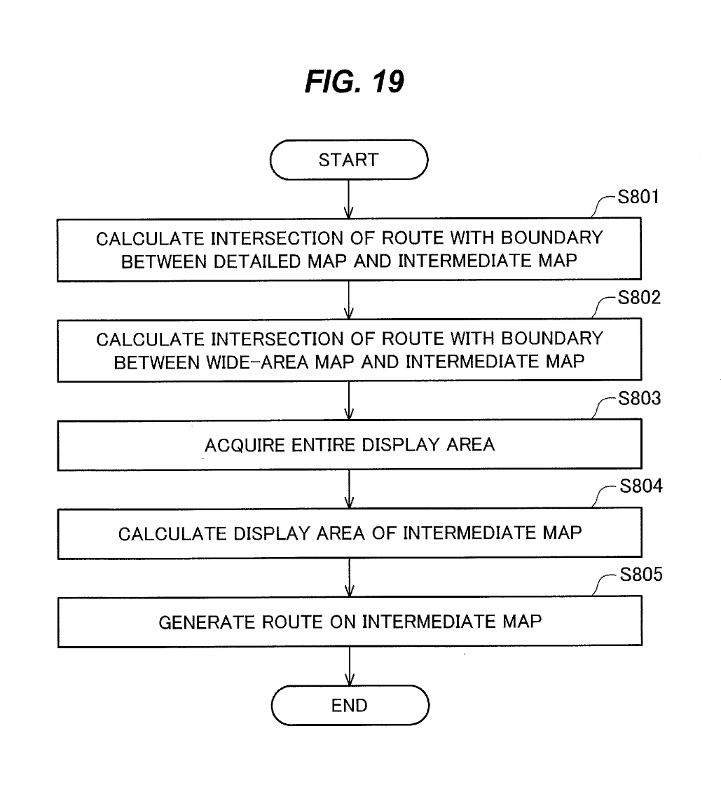

FIG. 19 is a flowchart illustrating the flow of the operation in step S800 of the intermediate map generator 200 of the second embodiment of the present invention.

In step S801, the intersection calculator 202 calculates an intersection of the route with the boundary between the detailed map and the intermediate map. The intersection calculator 202 acquires, from the detail area acquisition unit 404, the area (500×500 pixels) in which the detailed map is displayed on the display, the heading-up orientation, which is the associated orientation of the displayed map, and “ 1/100 m”, which is the value of the scale of the detailed map associated with the area in which the detailed map is displayed on the display, and acquires the route set by the user from the intermediate route acquisition unit 201. The intersection calculator 202 calculates the coordinates on the display of an intersection of the route set by the user with the boundary between the detailed map and the intermediate map, under the heading-up orientation and “ 1/100 m”, which is the value of the scale of the detailed map. The intersection calculator 202 sends the intersection on the display of the route set by the user with the boundary between the detailed map and the intermediate map, to the intermediate route generator 207.

In step S802, the intersection calculator 202 calculates an intersection of the route with the boundary between the wide-area map and the intermediate map. The intersection calculator 202 acquires, from the wide-area area acquisition unit 508, the area in which the wide-area map is displayed on the display, the heading-up orientation, which is the associated orientation of the displayed map, and “ 1/10 km”, which is the value of the scale of the wide-area map associated with the area in which the wide-area map is displayed on the display, and acquires the route set by the user from the intermediate route acquisition unit 201. The intersection calculator 202 calculates the coordinates on the display of an intersection of the route set by the user with the boundary between the wide-area map and the intermediate map, under the heading-up orientation and “ 1/10 km”, which is the value of the scale of the wide-area map. The intersection calculator 202 sends the intersection on the display of the route set by the user with the boundary between the wide-area map and the intermediate map, to the intermediate route generator 207.

In step S803, the display area acquisition unit 203 acquires the displayable area of the display. The display area acquisition unit 203 acquires, from the display area storage unit 6, the displayable area (e.g., 1024×1024 pixels) of the display, and sends the acquired displayable area (1024×1024 pixels) of the display, to the intermediate area calculator 204.

In step S804, the intermediate area calculator 204 calculates the area in which the intermediate map is displayed on the display. The intermediate area calculator 204 acquires, from the display area acquisition unit 203, the displayable area (1024×1024 pixels) of the display, acquires, from the detail area acquisition unit 404, the area (500×500 pixels) in which the detailed map is displayed on the display, and acquires, from the wide-area area acquisition unit 508, the area in which the wide-area map is displayed on the display. The intermediate area calculator 204 calculates the area in which the intermediate map is displayed on the display and that is calculated by subtracting the area in which the detailed map is displayed on the display and the area in which the wide-area map is displayed on the display from the displayable area of the display, by comparing the displayable area (1024×1024 pixels) of the display, the area (500×500 pixels) in which the detailed map is displayed on the display, and the area in which the wide-area map is displayed on the display. The intermediate area calculator 204 sends the area in which the intermediate map is displayed on the display, to the intermediate route generator 207.

In step S805, the intermediate route generator 207 generates the route on the intermediate map. The intermediate route generator 207 acquires, from the intersection calculator 202, the intersection of the route with the boundary between the detailed map and the intermediate map and the intersection of the route with the boundary between the wide-area map and the intermediate map, and acquires, from the intermediate area calculator 204, the area in which the intermediate map is displayed on the display. From the intersection of the route with the boundary between the detailed map and the intermediate map, the intersection of the route with the boundary between the wide-area map and the intermediate map, and the area in which the intermediate map is displayed on the display, the intermediate route generator 207 generates display information that is information on a route that is displayed on the intermediate map and connects the intersection of the route with the boundary between the detailed map and the intermediate map and the intersection of the route with the boundary between the wide-area map and the intermediate map, with a straight line, a curved line, or the like, in a deformed manner, in the area in which the intermediate map is displayed. The intermediate route generator 207 may acquire the route set by the user from the route storage unit 3, and deform and connect the route set by the user between the intersection of the route with the boundary between the detailed map and the intermediate map and the intersection of the route with the boundary between the wide-area map and the intermediate map. The intermediate route generator 207 sends the display information that is information on the route displayed on the intermediate map, to the map combiner 102b.

As described above, in the display device 100b illustrated in this embodiment, the intermediate map generator 200 connects the intersection of the route with the boundary between the detailed map and the intermediate map and the intersection of the route with the boundary between the wide-area map and the intermediate map, with a straight line, a curved line, or the like, in a deformed manner, in the area in which the intermediate map is displayed. This makes it possible, when maps with different scales are simultaneously displayed on the same screen, to display an entire route within the single screen in a continuous manner. Thus, when maps with different scales are simultaneously displayed on the same screen, the entire route can be seen at a glance.

Further, in the display device 100b illustrated in this embodiment, the intermediate map generator 200 connects the intersection of the route with the boundary between the detailed map and the intermediate map and the intersection of the route with the boundary between the wide-area map and the intermediate map, with a straight line, a curved line, or the like, in a deformed manner, in the area in which the intermediate map is displayed. This makes it possible to fix the scalds of the areas in which the detailed map and wide-area map are displayed even when the own vehicle is running, and reduce flicker of the maps due to change in the scales. Further, it is possible to fix the areas in which the detailed map and wide-area map are displayed even when the own vehicle is running, and reduce flicker of the maps due to change in the areas.

In the above display device 100b illustrated in this embodiment, the position of the own vehicle is acquired, but a starting point, a position designated by the user, or the like may be acquired. Also, in the above description, the end of the route is the destination, but it may be a position designated by the user, a transit point, the closest search result, or the like, or may be a point where attention is required in running, such as a point where the road is sharply curved or narrowed, a point where accidents frequently occur, a point under construction, or the like. A display device configured in this manner can display the entire route in a certain section and provide the above advantages of the second embodiment.

The above display device 100b illustrated in this embodiment uses a map including the position of the own vehicle as the detailed map and a map including the destination as the wide-area map, but it is also possible to use a map including the position of the own vehicle as the wide-area map and a map including the destination as the detailed map. A display device configured in this manner can also provide the above advantages of the second embodiment.

The above display device 100b illustrated in this embodiment arranges, in the display, the detailed map at the lower center of the wide-area map and the intermediate map in an area connecting the detailed map and the wide-area map. However, as long as the intermediate map is arranged in an area connecting the detailed map and the wide-area map, it is also possible to arrange the detailed map at the center, lower right, or the like of the wide-area map. The arrangement of the detailed map is determined from the relationship between the position of the own vehicle, the destination, and the orientation of the displayed map. A display device configured in this manner can also provide the above advantages of the second embodiment.

In the above display device 100b illustrated in this embodiment, the display device 100b is applied to a car navigation system, but this is not mandatory. The display device 100b is applicable to mobile terminals, mobile phones, desktop terminals, and any display devices that display maps on screens on the basis of map data. Display devices configured in this manner can also provide the above advantages of the second embodiment.

### Third Embodiment

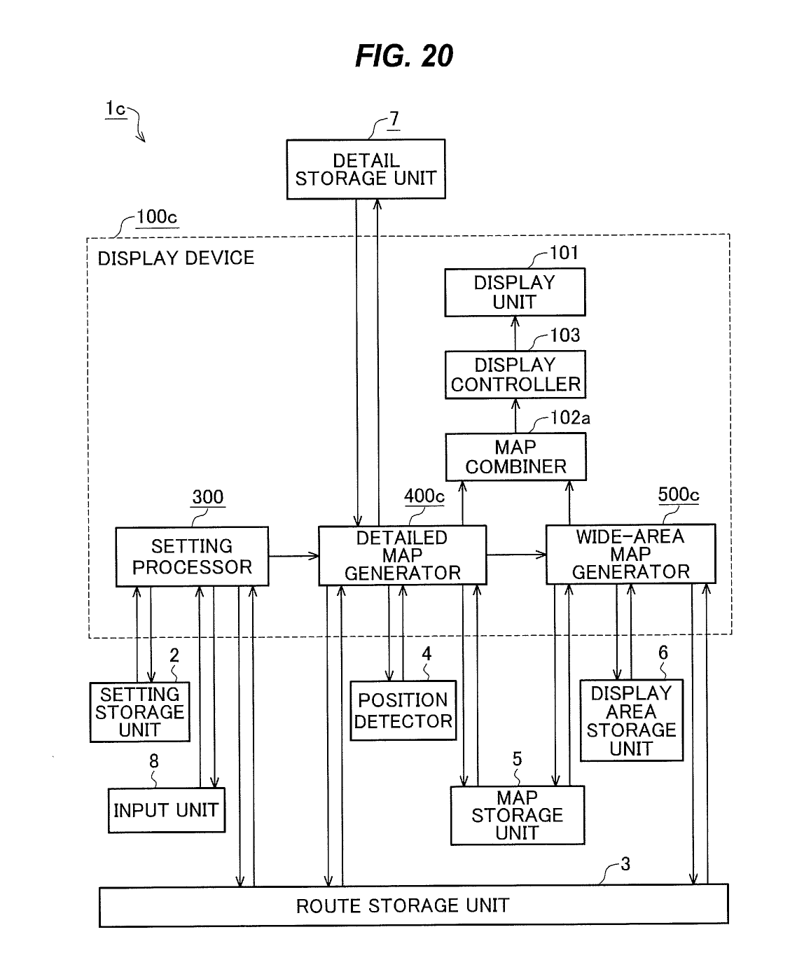

In the first embodiment, the detailed map and the wide-area map are connected at the boundary between the detailed map and the wide-area map such that the entire route is included. A display device 100c of a third embodiment differs in having a map effect generator 408 that generates a map extension effect, in addition to the configuration of the first embodiment, and superimposing at least part of the display information for the detailed map on the adjacent wide-area map, in an area that connects the area in which the detailed map is displayed and the area in which the wide-area map is displayed, as illustrated in FIGS. 20 to 26. With the provision of the map effect generator 408, a detailed map generator 400c and a wide-area map generator 500c are different in configuration from those of the first embodiment. Otherwise, the display device 100c is the same as that of the first embodiment. With this configuration, for example, by extending and displaying narrow roads, trademarks of shops, or the like displayed on the detailed map into the wide-area map, and further fading them, it is possible to provide smooth connection, which reduces the user's discomfort due to interruption at the wide-area map of narrow roads, trademarks of shops, or the like displayed on the detailed map. In the following description, parts and steps that have already been described will be given the same reference characters, and duplicate descriptions thereof will be omitted.

FIG. 20 is a diagram illustrating a configuration of a car navigation system 1c including the display device 100c according to the third embodiment.

The display device 100c simultaneously displays maps with different scales on the same screen and displays an entire route within the single screen in a continuous manner. Further, the display device 100c superimposes at least part of the display information for the detailed map on the adjacent wide-area map, in the area that connects the area in which the detailed map is displayed and the area in which the wide-area map is displayed. The display device 100c includes the detailed map generator 400c that generates the detailed map and the wide-area map generator 500c that generates the wide-area map. Otherwise, the display device 100c is the same as that of the first embodiment. However, the number setter 303 of the setting processor 300 sends the orientation of the displayed map to the detailed map generator 400c, not to the detailed map generator 400a. The map combiner 102a combines the detailed map generated by the detailed map generator 400c and the wide-area map generated by the wide-area map generator 500c, not the detailed map generated by the detailed map generator 400a and the wide-area map generated by the wide-area map generator 500a. The detailed map generator 400c and wide-area map generator 500c will be described in detail later.

It has been described that the display controller 103 determines a coordinate transformation matrix for the combined map, converts it into a signal that can be transmitted to the display unit 101 and read by the display unit 101, and sends the signal to the display unit 101. However, determining a coordinate transformation matrix for the combined map and converting it into a signal that can be transmitted to the display unit 101 and read by the display unit 101 may be performed by each of the detailed map generator 400c and wide-area map generator 500c, or may be performed by the map combiner 102a or the like.

The hardware configuration of the car navigation system 1c including the display device 100c according to the third embodiment of the present invention is the same as that of FIG. 2. The configuration of the car navigation system 1c including the display device 100c according to the third embodiment of the present invention will be described with reference to FIG. 2, wherein only parts different from those of the first embodiment will be described.

In the third embodiment, the car navigation system 1c including the display device 100c is a computer. The car navigation system 1c includes hardware components: a bus 11 that is a signal path, an input interface 12 that is a device for input by the user, a sensor 13 that detects the position of the own vehicle, a GPS receiver 14 that receives GPS data, a main memory 15 that is a work area, an external storage device 16 that stores programs, maps, or the like, a processor 17 that reads and executes the programs of the external storage device 16 that have been loaded into the main memory 15, and a display 18 that displays results from the respective devices. The display device 100c is implemented by part of the processor 17 and the display 18.

The processor 17 reads and executes programs of the external storage device 16 loaded into the main memory 15, thereby implementing the detailed map generator 400c and wide-area map generator 500c.

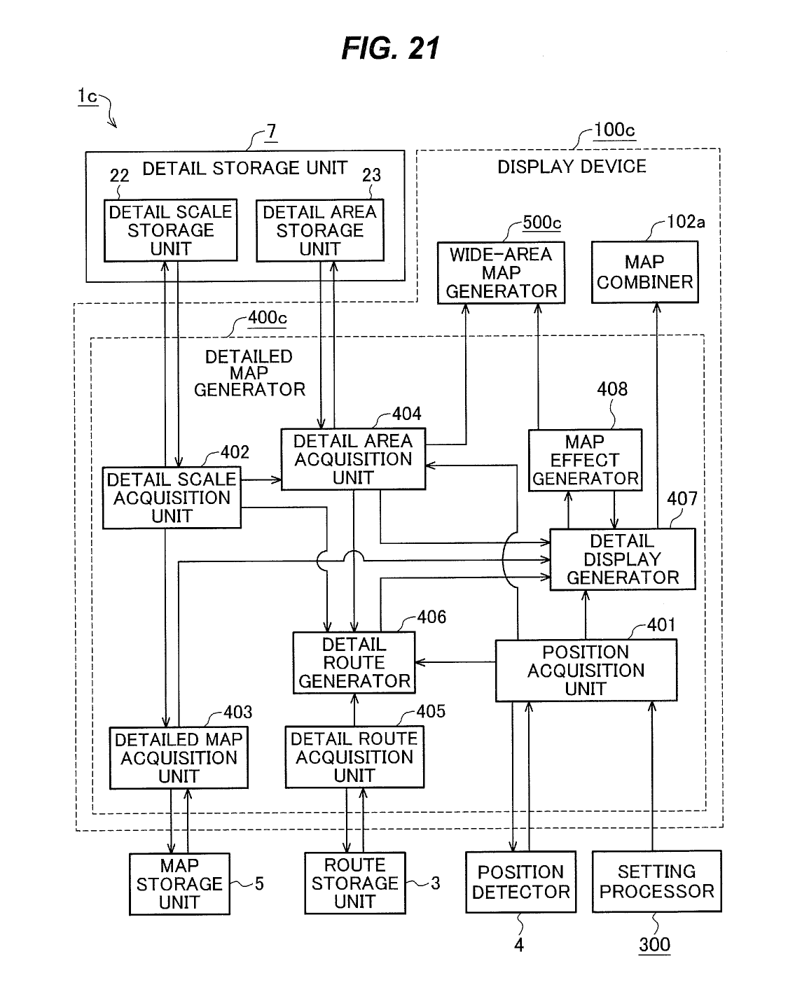

FIG. 21 is a diagram illustrating, in detail, a configuration of the detailed map generator 400c according to the third embodiment of the present invention. The detailed map generator 400c will be described in detail with reference to FIG. 21.

The detailed map generator 400c includes the map effect generator 408 that generates a map extension effect. Otherwise, the detailed map generator 400c is the same as that of the first embodiment. However, the detail display generator 407 sends the display information for the detailed map not only to the map combiner 102a but also to the map effect generator 408. Also, the detail area acquisition unit 404 sends the orientation of the displayed map, the value of the scale of the detailed map, the area in which the detailed map is displayed on the display, to the wide-area map generator 500c, not to the wide-area map generator 500a. As in the first embodiment, the area in which the detailed map is displayed on the display is an example of a first area, the position of the own vehicle is an example of a first position, the route displayed on the detailed map is an example of a first route, the detailed map is an example of a first map, the display information that is information for displaying the detailed map is an example of first display information, and the detail display generator 407 is an example of a first display information generator.

The map effect generator 408 generates the map extension effect. The map effect generator 408 generates, from the display information that is information for displaying the detailed map, effect display information that is information for extending information on roads, trademarks, or the like of the detailed map, from the boundary between the area in which the detailed map is displayed and the area in which the wide-area map is displayed, by a predetermined range, into the display information that is information for displaying the adjacent wide-area map, and displaying the extended information. In the third embodiment, the range by which the detailed map is extended is a stored predetermined range, but it may be a value input by the user or a calculated value. The display information that is information for displaying the detailed map is an example of one of first display information and second display information, and the display information that is information for displaying the wide-area map is an example of adjacent display information.

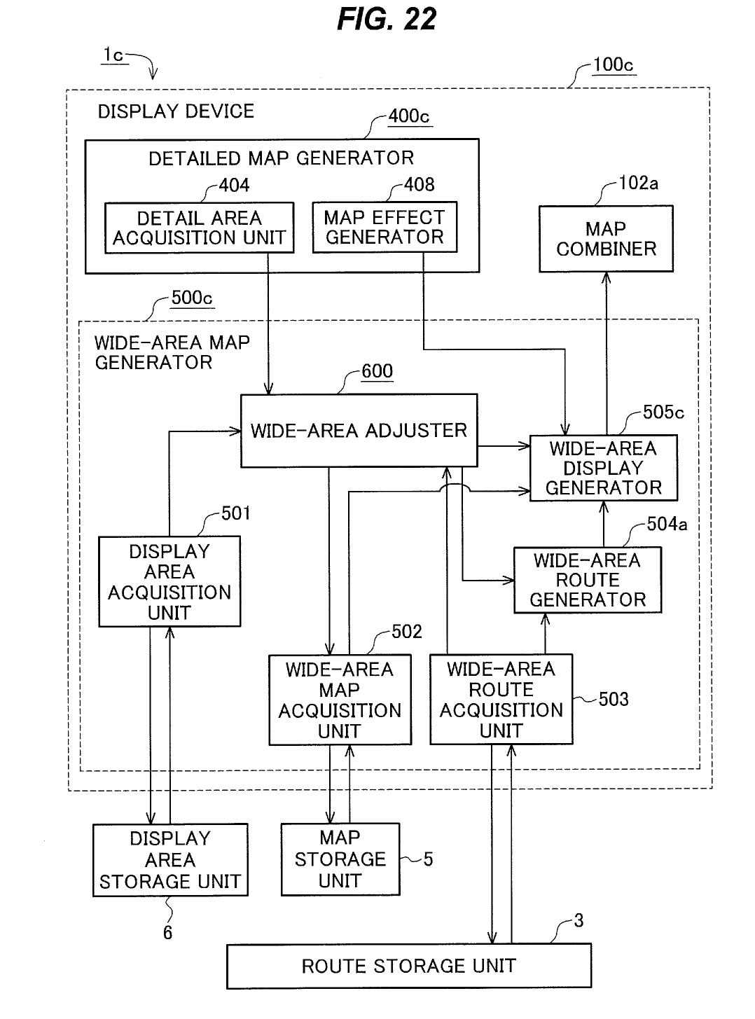

FIG. 22 is a diagram illustrating, in detail, a configuration of the wide-area map generator 500c according to the third embodiment of the present invention. The wide-area map generator 500c will be described in detail with reference to FIG. 22.

The wide-area map generator 500c includes a wide-area display generator 505c that generates display information for the wide-area map. Otherwise, the wide-area map generator 500c is the same as that of the first embodiment. However, the wide-area adjuster 600 sends the intersection of the route with the boundary between the detailed map and the wide-area map and the area in which the wide-area map is displayed on the display, to the wide-area display generator 505c, not to the wide-area display generator 505a. Also, the wide-area map acquisition unit 502 sends the map with the scale equal to the value of the scale of the wide-area map, to the wide-area display generator 505c, not to the wide-area display generator 505a. Further, the wide-area route generator 504a sends the display information that is information on the route displayed on the wide-area map, to the wide-area display generator 505c, not to the wide-area display generator 505a. The route set by the user is an example of an entire route, the destination is an example of a second position, the route displayed on the wide-area map is an example of a second route, the area in which the wide-area map is displayed on the display is an example of a second area, and the map with the scale equal to the value of the scale of the wide-area map is an example of a second map.

The wide-area display generator 505c generates the display information that is information for displaying the wide-area map. In addition to the first embodiment, the wide-area display generator 505c acquires the effect display information that is information for extending and displaying the information on roads, trademarks, or the like on the detailed map into the adjacent wide-area map, and generates the display information that is information for displaying the wide-area map and is added with the effect display information that is information for extending and displaying the information on roads, trademarks, or the like on the detailed map into the adjacent wide-area map. In the above description, the wide-area map generator 505c generates the display information that is information for displaying the wide-area map, adding the effect display information that is information for extending and displaying the information on roads, trademarks, or the like on the detailed map into the adjacent wide-area map. However, the map combiner 102a may combine the effect display information that is information for extending and displaying the information on roads, trademarks, or the like on the detailed map into the adjacent wide-area map, with the display information that is information for displaying the wide-area map and that does not include the effect display information. The display information that is information for displaying the wide-area map is an example of second display information, and the wide-area display generator 505c is an example of a second display information generator.

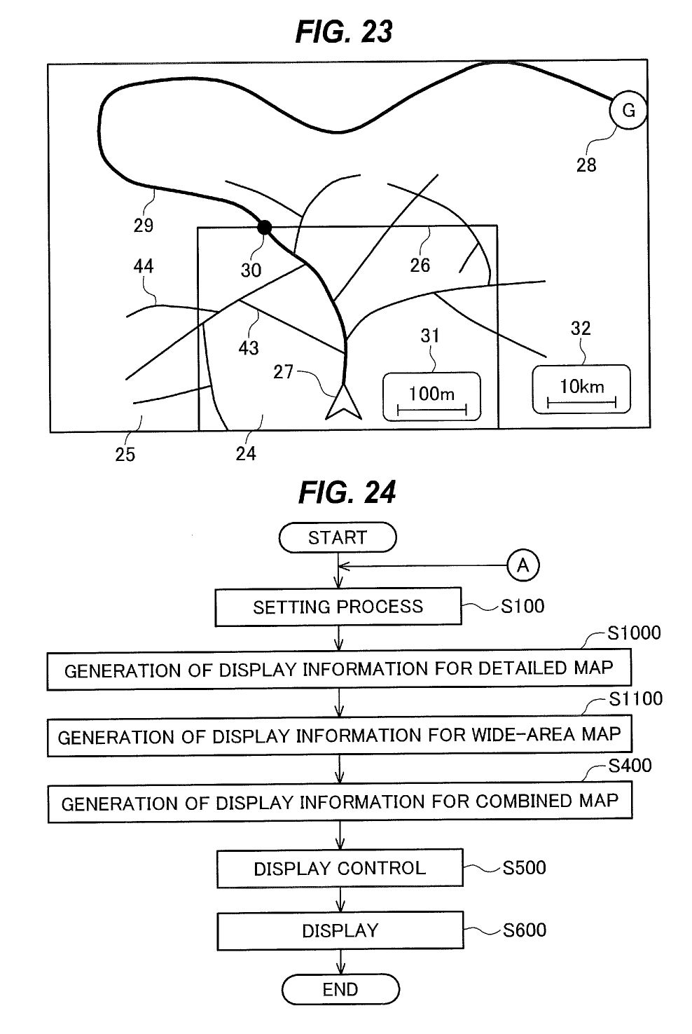

FIG. 23 is an example of display by the display according to the third embodiment. In addition to the first embodiment, for example, roads 44 extended from roads 43 displayed in the area 24 in which the detailed map is displayed on the display are superimposed and displayed on a predetermined area of the area 25 in which the wide-area map is displayed on the display, the predetermined area extending from the boundary between the area 24 in which the detailed map is displayed on the display and the area 25 in which the wide-area map is displayed on the display. The farther the extended roads 44 are from the boundary between the area 24 in which the detailed map is displayed on the display and the area 25 in which the wide-area map is displayed on the display, the more lightly the extended roads are displayed. In this manner, the extended roads 44 are displayed more lightly as they extend farther from the boundary between the area 24 in which the detailed map is displayed on the display and the area 25 in which the wide-area map is displayed on the display. This can make the connection smoother, thereby reducing the user's discomfort. Although in the third embodiment, only roads are displayed, trademarks, the background, the color, or the like may be superimposed and displayed. As in the first embodiment, in FIG. 23, a scale indicator 31 of the detailed map and a scale indicator 32 of the wide-area map are displayed so that the scales can be seen at a glance, but they need not necessarily be displayed. Instead of the scale indicators, grid lines may be displayed in a superimposed manner. Also in this case, the scales can be seen at a glance.

Next, the operation of the display device 100c according to the third embodiment of the present invention will be described.

FIG. 24 is a flowchart illustrating the flow of the operation of the display device 100c of the third embodiment of the present invention. The operation of the display device 100c will be described below with reference to FIG. 24. In the following description, steps that have already been described will be given the same reference characters, and duplicate descriptions thereof will be omitted.

Steps S100, S400, S500, and S600 are the same as steps S100, S400, S500, and S600 of the first embodiment, so only steps S1000 to S1100 will be described. However, in the process in step S100, the number setter 303 of the setting processor 300 sends the orientation of the displayed map to the detailed map generator 400c instead of the detailed map generator 400a. In the process in step S400, the map combiner 102a combines the detailed map generated by the detailed map generator 400c and the wide-area map generated by the wide-area map generator 500c instead of the detailed map generated by the detailed map generator 400a and the wide-area map generated by the wide-area map generator 500a.

In step S1000, the detailed map generator 400c generates the display information for the detailed map.

In step S1100, the wide-area map generator 500c generates the display information for the wide-area map.

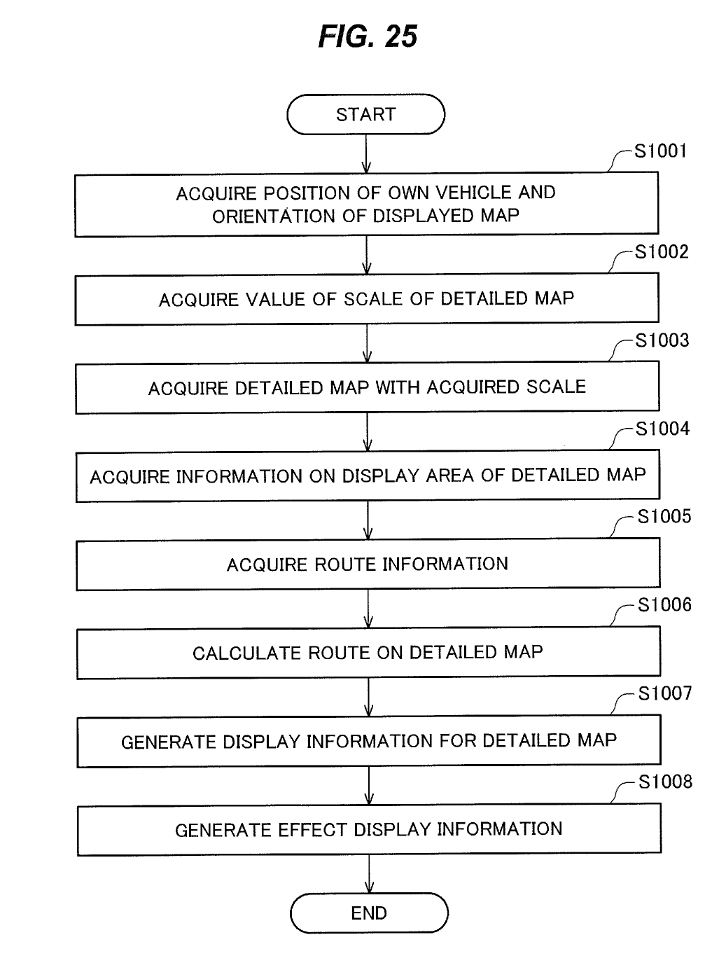

FIG. 25 is a flowchart illustrating the flow of the operation in step S1000 of the detailed map generator 400c of the third embodiment of the present invention.

Steps S1001 to S1007 are the same as steps S201 to S207 of the first embodiment, so only step S1008 will be described. However, in step S1004, the detail area acquisition unit 404 sends the orientation of the displayed map, the value of the scale of the detailed map, and the area in which the detailed map is displayed on the display, to the wide-area map generator 500c instead of the wide-area map generator 500a. In step S1007, the detail display generator 407 sends the display information for the detailed map not only to the map combiner 102a but also to the map effect generator 408.

In step S1008, the map effect generator 408 generates the effect display information. The map effect generator 408 generates, from the display information for the detailed map acquired from the detail map display generator 407, effect display information that is information for extending and displaying information on roads, trademarks, or the like on the detailed map, from the boundary between the area in which the detailed map is displayed and the area in which the wide-area map is displayed, by a predetermined range (e.g., a width of 10 pixels), into the adjacent wide-area map. In the third embodiment, the area into which the detailed map is extended is a stored predetermined area, but it may be a value input by the user, or a calculated value. The map effect generator 408 sends the effect display information that is information for extending and displaying the information into the wide-area map, to the wide-area map generator 500c.

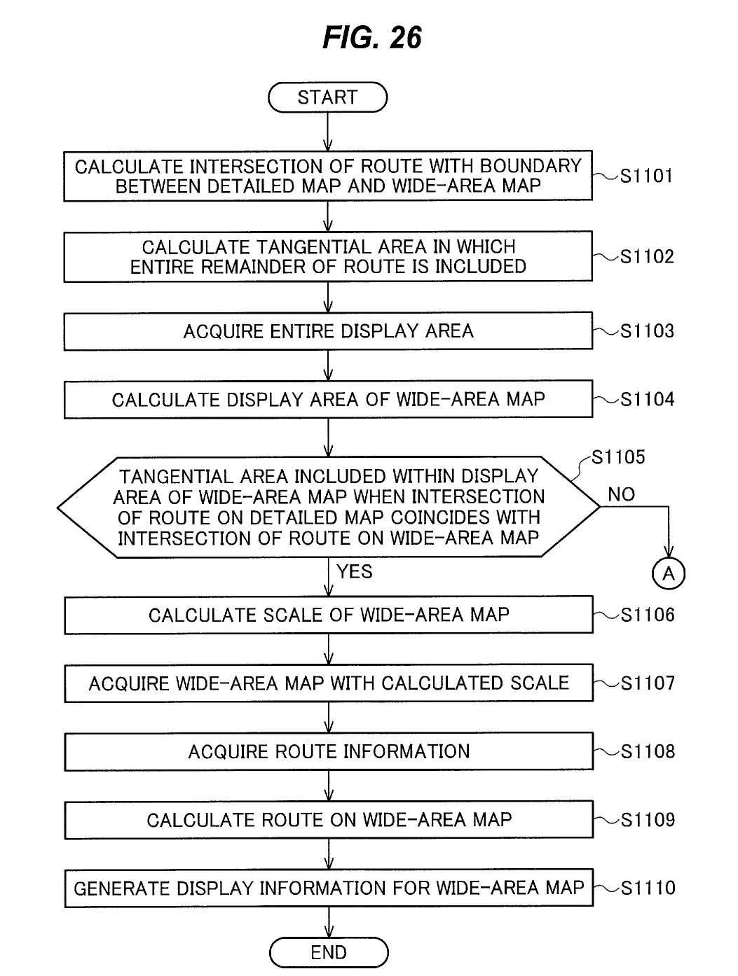

FIG. 26 is a flowchart illustrating the flow of the operation in step S1100 of the wide-area map generator 500c of the third embodiment of the present invention.

Steps S1101 to S1109 are the same as steps S301 to S309 of the first embodiment, so only step S1110 will be described. However, in step S1101, the intersection calculator 601 sends the intersection of the route with the boundary between the detailed map and the wide-area map, to the wide-area display generator 505c instead of the wide-area display generator 505a. In step S1104, the wide-area area calculator 603 sends the area in which the wide-area map is displayed in the display, to the wide-area display generator 505c instead of the wide-area display generator 505a. In step S1107, the wide-area map acquisition unit 502 sends the map with the scale that is the same as the value of the scale of the wide-area map, to the wide-area display generator 505c instead of the wide-area display generator 505a. In step S1109, the wide-area route generator 504a sends the display information that is information on the route displayed on the wide-area map, to the wide-area display generator 505c instead of the wide-area display generator 505a.

In step S1110, the wide-area display generator 505c generates the display information that is information for displaying the wide-area map. In addition to the first embodiment, the wide-area display generator 505c acquires, from the map effect generator 408, the effect display information that is information for extending and displaying the information on roads, trademarks, or the like on the detailed map, from the boundary between the area in which the detailed map is displayed and the area in which the wide-area map is displayed, by a width of 10 pixels, into the adjacent wide-area map. The wide-area display generator 505c generates the display information that is information for displaying the wide-area map and is added with the effect display information that is information for extending and displaying the information on roads, trademarks, or the like on the detailed map, from the boundary between the area in which the detailed map is displayed and the area in which the wide-area map is displayed, by a width of 10 pixels, into the adjacent wide-area map. The wide-area display generator 505c sends the display information to the map combiner 102a.

As described above, as in the first embodiment, in the display device 100c illustrated in this embodiment, the wide-area map generator 500c arranges the route of the wide-area map in such a manner that the route of the wide-area map is connected to the intersection of the route with the boundary between the detailed map and the wide-area map, and calculates a scale of the wide-area map such that the tangential area is included within the area in which the wide-area map is displayed on the display, and generates the wide-area map on the basis of the calculated scale. This makes it possible to display an entire route within a single screen in a continuous manner when maps with different scales are simultaneously displayed on the same screen. Thus, even when the maps with the different scales are simultaneously displayed on the same screen, the entire route can be seen at a glance.

Further, the map storage unit 5 stores multiple maps with different scales, they are added with information on the background, including mountains, rivers, towns, or the like, information on roads, and information on trademarks or the like, depending on the scale. Thus, in some cases, narrow roads, trademarks of shops, or the like added to the detailed map are not added to the wide-area map. In such a case, the narrow roads, trademarks of shops, or the like displayed on the detailed map end at the wide-area map, which discomforts the user. However, in the display device 100c illustrated in this embodiment, the map effect generator 408 generates the map extension effect, and the wide-area display generator 505c generates the effect display information that is information for displaying the wide-area map and added with the map extension effect. Thus, by extending and displaying narrow roads, trademarks of shops, or the like displayed on the detailed map into the wide-area map, and further fading them, it is possible to provide smooth connection, which reduces the user's discomfort. The wide-area map may be extended into the detailed map.

As in the first embodiment, in the above display device 100c illustrated in this embodiment, the wide-area map generator 500c arranges the route of the wide-area map in such a manner that the route of the wide-area map is connected to the intersection of the route with the boundary between the detailed map and the wide-area map, and calculates a scale of the wide-area map such that the tangential area is included within the area in which the wide-area map is displayed on the display, and generates the wide-area map on the basis of the calculated scale. However, it is possible that the wide-area map is generated first, and the detailed map generator 400c arranges the route of the detailed map in such a manner that the route of the detailed map is connected to the intersection of the route with the boundary between the detailed map and the wide-area map, and calculates a scale of the detailed map such that the tangential area is included within the area in which the detailed map is displayed on the display, and generates the detailed map on the basis of the calculated scale. A display device configured in this manner can also provide the above advantages of the third embodiment.

As in the first embodiment, in the above display device 100c illustrated in this embodiment, the position of the own vehicle is acquired, but a starting point, a position designated by the user, or the like may be acquired. Also, in the above description, the end of the route is the destination, but it may be a position designated by the user, a transit point, the closest search result, or the like, or may be a point where attention is required in running, such as a point where the road is sharply curved or narrowed, a point where accidents frequently occur, a point under construction, or the like. A display device configured in this manner can display the entire route in a certain section and provide the above advantages of the third embodiment.

As in the first embodiment, the above display device 100c illustrated in this embodiment calculates the scale of the wide-area map from the detailed map, but it is also possible to calculate the scale of the detailed map from the wide-area map. A display device configured in this manner can also provide the above advantages of the third embodiment.

As in the first embodiment, the above display device 100c illustrated in this embodiment uses a map including the position of the own vehicle as the detailed map and a map including the destination as the wide-area map, but it is also possible to use a map including the position of the own vehicle as the wide-area map and a map including the destination as the detailed map. A display device configured in this manner can also provide the above advantages of the third embodiment.

As in the first embodiment, the above display device 100c illustrated in this embodiment arranges the detailed map at the lower center of the wide-area map in the display, but it is also possible to arrange the detailed map at the center, lower right, or the like of the wide-area map. The arrangement of the detailed map is determined from the relationship between the position of the own vehicle, the destination, and the orientation of the displayed map. A display device configured in this manner can also provide the above advantages of the third embodiment.

As in the first embodiment, in the above display device 100c illustrated in this embodiment, the tangential area calculator 602 calculates the tangential area that touches the route from the intersection of the route with the boundary between the detailed map and the wide-area map to the coordinates of the destination. However, it is also possible to set, for example, a circular region centered at the destination and surrounding 20 m as a predetermined region, and calculate a tangential area that touches the route from the intersection of the route with the boundary between the detailed map and the wide-area map to the region of the destination. When the tangential area calculator 602 takes coordinates as the destination, the destination can be located on the boundary of the tangential area. However, when the tangential area calculator 602 takes a predetermined region as the destination, the destination is not located on the boundary of the tangential area, and thus is easy to see. A display device configured in this manner prevents the destination from being displayed on the boundary of display of the display, thereby improving visibility, in addition to the above advantages of the first embodiment. The predetermined region surrounding the destination may be a rectangular region, instead of a circular region. The destination may be located at a position displaced from the center in a direction, instead of the center.

As in the first embodiment, in the above display device 100c illustrated in this embodiment, the display device 100c is applied to a car navigation system, but this is not mandatory. The display device 100c is applicable to mobile terminals, mobile phones, desktop terminals, and any display devices that display maps on screens on the basis of map data. Display devices configured in this manner can also provide the above advantages of the third embodiment.

The above display device 100c illustrated in this embodiment extends and displays the information on roads, trademarks, or the like of the detailed map, from the boundary between the area in which the detailed map is displayed and the area in which the wide-area map is displayed, by a width of 10 pixels, into the adjacent wide-area map. However, the width of display from the boundary between the area in which the detailed map is displayed and the area in which the wide-area map is displayed may be any value, such as 20 or 50 pixels. Further, the area may be an area surrounded by a curved line, instead of an area obtained by combining rectangles. Display devices configured in this manner can also provide the above advantages of the third embodiment.

The above display device 100c illustrated in this embodiment extends and displays the information on roads, trademarks, or the like of the detailed map, from the boundary between the area in which the detailed map is displayed and the area in which the wide-area map is displayed, by a width of 10 pixels, into the adjacent wide-area map. However, it is also applicable to a case of having the intermediate map as in the second embodiment. A map effect generator that extends the detailed map is added to the detailed map generator 400a, as with the detailed map generator 400c; a map effect generator that extends the wide-area map is added to the wide-area map generator 500b, as with the detailed map generator 400c; the intermediate map generator 200 is configured so that the intermediate route generator 207 generates display information for the intermediate map that is added with the effect display information that is information for extending and displaying the detailed map and the wide-area map into the intermediate map, as with the wide-area map generator 500c. This configuration makes it possible to extend and display the detailed map and the wide-area map into the intermediate map. Thus, by extending and displaying roads, trademarks of shops, or the like displayed on the detailed map and wide-area map into the adjacent intermediate map, and further fading them, it is possible to provide smooth connection, which reduces the user's discomfort. It is also possible to extend only one or some of the detailed map, wide-area map, and intermediate map. Display devices configured in this manner can also provide the above advantages of the third embodiment.

The display devices illustrated in the above embodiments are merely examples, and may be combined as appropriate; it is not limited to the configuration of each of the embodiments.

### REFERENCE SIGNS LIST

1a, 1b, 1c car navigation system, 2 setting storage unit, 3 route storage unit, 4 position detector, 5 map storage unit, 6 display area storage unit, 7 detail storage unit, 8 input unit, 9 wide-area storage unit, 11 bus, 12 input interface, 13 sensor, 14 GPS receiver, 15 main memory, 16 external storage unit, 17 processor, 18 display, 19 steering angle sensor, 20 gyro sensor, 21 speed sensor, 22 detail scale storage unit, 23 detail area storage unit, 24 area in which detailed map is displayed on display, 25 area in which wide-area map is displayed on display, 26 boundary between area in which detailed map is displayed on display and area in which wide-area map is displayed on display, 27 position of own vehicle, 28 destination, 29 route from position of own vehicle to destination, 30 intersection, 31 scale indicator for detailed map, 32 scale indicator for wide-area map, 33 area, 34 wide-area scale storage unit, 35 wide-area area storage unit, 37 area in which intermediate map is displayed on display, 38 boundary between area in which detailed map is displayed on display and area in which intermediate map is displayed on display, 39 boundary between area in which wide-area map is displayed on display and area in which intermediate map is displayed on display, 40 intersection, 41 intersection, 43 roads displayed in area in which detailed map is displayed on display, 44 roads extended from roads displayed in area in which detailed map is displayed on display, 100a, 100b, 100c display device, 101 display unit, 102a, 102b map combiner, 103 display controller, 200 intermediate map generator, 201 intermediate route acquisition unit, 202 intersection calculator, 203 display area acquisition unit, 204 intermediate area calculator, 207 intermediate route generator, 300 setting processor, 301 route setting determiner, 302 orientation setter, 303 number setter, 400a, 400c detailed map generator, 401 position acquisition unit, 402 detail scale acquisition unit, 403 detailed map acquisition unit, 404 detail area acquisition unit, 405 detail route acquisition unit, 406 detail route generator, 407 detail display generator, 408 map effect generator, 500a, 500b, 500c wide-area map generator, 501 display area acquisition unit, 502 wide-area map acquisition unit, 503 wide-area route acquisition unit, 504a, 504b wide-area route generator, 505a, 505b, 505c wide-area display generator, 506 orientation acquisition unit, 507 wide-area scale acquisition unit, 508 wide-area area acquisition unit, 600 wide-area adjuster, 601 intersection calculator, 602 tangential area calculator, 603 wide-area area calculator, 604 arrangement determiner, 605 wide-area scale calculator.

1. A display device comprising:
a first display information generator to generate first display information that is information for displaying, in a first area, a first map and a first route including a first position in the first area, the first area being located at a predetermined position, a position determined by input to the display device, or a position calculated by the display device;
a second display information generator to calculate an intersection of an entire route with a boundary of the first area, calculate a tangential area in which a second route connecting a second position and the intersection is inscribed, determine, when the tangential area is included within a second area in a state in which the first route and the second route are connected to each other at the intersection, a scale at which the tangential area is included within the second area when the first route and the second route are displayed in such a manner as to be connected to each other at the intersection, and generate second display information that is information for displaying, in the second area, a second map with the scale and the second route; and
a display controller to control displaying the first display information and the second display information in a combined manner on a display.

2-3. (canceled)

4. The display device of claim 1, further comprising a map effect generator to generate effect display information that is information for displaying one of the first display information and the second display information in such a manner that the one display information is extended and superimposed on the other adjacent display information,
wherein the display controller controls displaying the effect display information on the display.

5. The display device of claim 4, wherein the effect display information fades display as the display information is extended.

6-7. (canceled)

8. The display device of claim 1, further comprising a display to display information under control of the display controller.

9. The display device of claim 4, further comprising a display to display information under control of the display controller.

10. The display device of claim 5, further comprising a display to display information under control of the display controller.
